(19) United States
(12) Patent Application Publication
(10) Pub. No.: US 2021/0169106 A1
(43) Pub. Date: Jun. 10, 2021

(54) THYMOHYDROQUINONE BASED SYSTEM FOR HUMAN AND PET FOOD AND RELATED METHODS

(71) Applicant: KEMIN INDUSTRIES, INC., DES MOINES, IA (US)

(72) Inventors: Lan Ban, West Des Moines, IA (US); Chi-Yu Shen, Ames, IA (US); William David Schroeder, Ames, IA (US); Kristen Robbins Junker, Ankeny, IA (US); Yvonne Gildemaster, West Des Moines, IA (US); Ewa Szajna-Fuller, Ames, IA (US); Carrie Wray, Des Moines, IA (US)

(21) Appl. No.: 17/091,780

(22) Filed: Nov. 6, 2020

Related U.S. Application Data
(60) Provisional application No. 63/035,265, filed on Jun. 5, 2020.
(60) Provisional application No. 62/933,103, filed on Nov. 8, 2019.

(51) Int. Cl. A23L 3/349; A23L 3/3472; A23P 20/18; A23D 9/06; A23D 9/04; A23K 20/111; A23K 30/00; A23K 40/30; A23K 50/40; A23K 10/30

(52) U.S. Cl. CPC A23L 3/349; A23L 3/3472; A23P 20/18; A23D 9/06; A23D 9/04; A23V 2002/00; A23K 30/00; A23K 40/30; A23K 50/40; A23K 10/30; A23K 20/111

(57) ABSTRACT

The present invention relates to additive ingredients for stabilizing food compositions, as well as methods of stabilizing foods and pet foods using thymohydroquinone (THQ), alone or in synergistic combination with other antioxidants. The use of THQ to prevent oxidation of foods and pet foods has been found to be surprisingly effective in stabilizing all representative food matrices, including fats/oils, fatty foods, baked goods, and meat/poultry.

### CROSS-REFERENCE TO RELATED APPLICATIONS

This application claims the benefit of priority to U.S. Provisional Patent Application No. 63/035,265, filed Jun. 5, 2020, entitled “THYMOHYDROQUINONE BASED SYSTEM FOR HUMAN AND PET FOOD AND RELATED METHODS,” and U.S. Provisional Patent Application No. 62/933,103, filed Nov. 8, 2019, entitled “THYMOHYDROQUINONE BASED SYSTEM FOR HUMAN AND PET FOOD AND RELATED METHODS,” the entire disclosures of which are incorporated herein by reference in their entirety.

### BACKGROUND OF THE INVENTION

The present invention relates generally to an ingredient for food and pet foods, more specifically, to the use of thymohydroquinone (THQ) as an ingredient, alone or in synergistic combination with other antioxidants, for delaying oxidation in food and pet food.

Oils and fats, along with food matrices that contain oil and fat, including pet food, are susceptible to lipid oxidation, which causes off odors, off flavors, and rancidity. The use of antioxidants in these matrices help inhibit or delay lipid oxidation and, therefore, lengthens the shelf life of the product. Tocopherols are traditionally used as antioxidants used in pet food.

Seeds of Nigella sativa (black seed or black cumin), a dicotyledon of the Ranunculaceae family, have been used for thousands of years as a spice and food preservative. Black cumin is an annual herbaceous plant widely grown in the Mediterranean countries, Middle East, Eastern Europe and Western Asia. In the Middle East, Northern Africa and India, it has been used traditionally for centuries for the treatment of asthma, cough, bronchitis, headache, rheumatism, fever, influenza and eczema and for its antihistaminic, antidiabetic and anti-inflammatory activities.

The oil and the seed constituents of black seeds, in particular thymoquinone (TQ), have shown potential medicinal properties, including anti-inflammatory effects, beneficial immunomodulatory properties, as well as anti-microbial and anti-tumor properties. Other functional components of the black seed oil include p-cymene, carvacrol, thymohydroquinone (THQ), α-thujene, thymol, t-anethold, β-pinene, α-pinene, and γ-terpinene.

Tertiary butylhydroquinone (TBHQ), beta hydroxyl acid (BHA) and butylated hydroxytoluene (BHT) are effective synthetic antioxidants for food shelf life extension. However, they are synthetic and currently not preferred over natural antioxidants. Antioxidants from plant origins, with equal efficacy are highly needed in the market. However, so far, there has been no ingredients that demonstrate equal efficacy compared to synthetic antioxidants and there are no natural ingredients that have shown broad applications in various foods. For example, rosemary extract with carnosic acid/carnosol as active molecules is a powerful antioxidant in a protein matrix, but only have limited efficacy in dressing/mayo and bulk oils. The successful development of thymohydroquinone (THQ) that is in blend with other antioxidants would be beneficial for food/pet food industry with broad application areas.

For these and other reasons, there has been a long-felt need for the present invention.

### SUMMARY OF THE INVENTION

The present invention relates to methods of increasing the stability of various types of foods and pet foods through the addition of thymohydroquinone (THQ) or THQ-containing monarda extract, with or without other antioxidants that have been shown to provide additive or synergistic effect, such as rosemary extract, ascorbic acid, or oil soluble green tea. The compositions of the invention have surprisingly been found to be effective in all representative food matrices, including fats/oils, fatty foods, and meat/poultry.

### BRIEF DESCRIPTION OF THE FIGURES

FIG. 1 depicts the chemical structures of four constituents of Monarda essential oil (MEO), namely TQ, carvacrol, thymol, and THQ.

FIG. 2 shows the results of initial antioxidant screening. Monarda essential oil was used to treat canola oil. Samples were analyzed for degree of oxidation by measuring peroxide value generation Samples were analyzed for secondary oxidation by measuring hexanal and 2,4-decadienal content. Rosemary extract was used as a positive control.

FIG. 3 shows the results of initial antioxidant screening. Monarda essential oil was used to treat chicken fat. Samples were analyzed for degree of oxidation by measuring peroxide value generation Samples were analyzed for secondary oxidation by measuring hexanal and 2,4-decadienal content. Rosemary extract was used as a positive control.

FIG. 4A and FIG. 4B show the HPLC analysis of Monarda essential oil (MEO).

FIG. 5A and FIG. 5B show peroxide values throughout the study and hexanal and 2,4-decadienal content at the final testing point, week 24.

FIG. 6 shows the results of antioxidant activity of thymohydroquinone compared with tert-butylhydroquinone in canola oil, fish oil, and chicken fat.

FIG. 7 shows peroxide values and aldehyde content of kibble containing THQ, TBHQ and CA applied to the canola oil coated on its surface.

FIGS. 8 and 9 show peroxide values in an antioxidant activity test of thymohydroquinone in combination with tocopherols and rosemary extract when used in pet food.

FIG. 10 shows peroxide values for fish meal treated with two different formulations.

FIG. 11 shows a summary of oxidative byproducts generation.

FIGS. 12 to 15 show peroxide analysis results for four separate THQ dosage groups.

FIG. 16 shows a main effect plot for PV.

FIGS. 17 and 18 show antagonistic effects among three plant extracts.

FIG. 19 shows peroxide values of synergy between TQ and ascorbic acid.

FIG. 20 shows OSI results of THQ, ascorbic acid and their combinations.

FIGS. 21 and 22 show storage stability of soybean oil treated with rosemary extract, THQ containing Monarda extract and their combination.

FIGS. 23 and 24 show storage stability of soybean oil treated with GT-FORT, THQ containing Monarda extract and their combination.

FIG. 25 shows a two-way ANOVA of TBARS values during a 14-day refrigerated storage period.

FIG. 26 shows sensory acceptance scores of 8-day refrigerated patties.

FIG. 27 shows TBARS values during a 11-day refrigerated storage period.

FIG. 28 shows a two-way ANOVA of TBARS values.

FIG. 29 shows photos of ground pork patties.

### DETAILED DESCRIPTION OF THE INVENTION

Thymohydroquione (THQ) was identified by the researches as an effective ingredient in delaying oxidations in food and pet food. Its precursor, thymoquinone (TQ), also known as 2-isopropyl-5-methylbenzo-1,4-quinone, is a known molecule that is present in relatively large quantities in various plant materials. Applicant has recently developed a high TQ containing Monarda fistulosa plant clonal line, and the plant material was distilled to produce high TQ containing essential oil. The present invention, however, can be obtained from any TQ-containing source, including Nigella sativa and in select Monarda plants, including Monarda fistulosa, Monarda punctata, Monarda didyma, and Monarda citriodora. TQ has the following chemical structure:

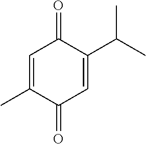

The precursor TQ can be reduced to THQ through known methods of reduction. Such methods are well-known to persons skilled in the art, including conventional reduction methods, such as use of metals and other reducing agents.

The inventors have unexpectedly discovered efficacy using THQ or THQ, in the form of extract from the Monarda plant, as an antioxidant in pet food, for instance as an antioxidant in chicken meal. Furthermore, the inventors have identified additive or synergistic pairs from THQ combination with other known antioxidative molecules. These pairs include TQ+ascorbic acid, THQ+ascorbic acid, THQ+rosemary extract, THQ+oil soluble green tea extract and the applications of them in various human and pet food matrices. The TQ or THQ sources could be from the pure compounds, or from the TQ or THQ containing plant extract. The discovery of the combinations provides more effective antioxidant solutions to delay lipid oxidations in food and pet food systems. Persons of ordinary skill in the art would will recognize that a reducing agent also needs to be present.

The present invention may be used to treat and prevent oxidation of any type of food or pet food matrix, including, but not limited to, fats/oils, food emulsions (oil-in-water or water-in-oil), fatty foods, and meat/poultry liquids, fibrous materials, crystals, and porous structures.

THQ can be added to any ingredient of pet food and human food prior to pet food and human food production, such as rendered protein meals, animal proteins, animal fats/oils, or vegetable oils. Rendered protein meals used in pet food include chicken, poultry, beef, pork or fish meal. Animal proteins include ground meat or whole muscle of chicken, beef, and pork for human consumption. THQ can be also added to the dry mix as a treatment of the core of the pet food or added in the dry mix/liquid brine that will be incorporated into human food in the downstream processing.

Additionally, THQ-containing fat/oil can be added to the pet food during the manufacturing process or coated onto the surface of finished pet food, or added to the bakery formulation for making baked goods. THQ can be added to any type of pet food, such as dry extruded pet food or wet pet food.

According to at least one embodiment, in one aspect of the process, the food or pet food is treated with a source of THQ. Any source of THQ is suitable for this purpose, including the THQ sources, such as from the Monarda fistulosa, Monarda punctata, Monarda didyma, and Monarda citriodora and Nigella sativa plants. In addition, the THQ may be obtained through the addition of TQ with subsequent reduction to THQ through the addition of a reducing agent or through other reduction means. In alternative embodiments, synthetic THQ can be used.

The THQ or THQ source can generally be combined with the food or pet food product in an amount to provide THQ, either initially or following reduction, of between about 10-1000 ppm/weight of the food or pet food product, and according to at least one embodiment about 20-500 ppm. The ingredients are optionally mixed at room temperature (25-30° C.) with agitation. According to at least one embodiment, the ingredients are mixed at varying temperatures, for instance refrigerated temperatures or temperatures cooler than room temperature. In alternative embodiments, the ingredients may be mixed at elevated temperatures, such as 30-40° C.

According to at least one embodiment, the ingredients are optionally mixed with agitation to improve miscibility. The ingredients can also be mixed without agitation.

In at least one embodiment of the invention, the THQ is applied as a coating to the food or pet food product by spraying or other conventional means.

The inventors have surprisingly discovered that THQ is an antioxidant in Monarda plants and/or extracts that results in superior antioxidant activity, and according to at least one embodiment was responsible for the best antioxidant results when combined with food products. As such, depending on the specific application, persons of ordinary skill may desire to isolate and only include the THQ component of Monarda (or other plant sources of THQ) as an antioxidant in the food/pet food product for purposes of cost, providing less of a taste to the food, etc. Therefore, in at least one embodiment of the invention, THQ is the sole antioxidant added to, mixed with or applied to the food or pet food composition.

In another embodiment of the invention, at least one other antioxidant ingredient can be included with the THQ to provide an additive/synergistic antioxidant effect with the food or pet food product. Such antioxidants include spearmint, rosemary, acerola extract, ascorbic acid, and green tea. If included, the spearmint should be included in a range of about 10-1000 ppm, the ascorbic acid in an amount of about 100-1000 ppm, the green tea in an amount of about 1000-3500 ppm, and the rosemary in an amount of about 50-500 ppm. In at least one embodiment of the present invention, the only antioxidants included with the food/pet food are THQ and at least one of spearmint, ascorbic acid, green tea, or rosemary.

The ingredients of the invention can either be mixed sequentially or can be added all at once to the food or pet food to achieve the unique composition of the invention. In at least one embodiment of the present invention, the THQ and/or the other antioxidant are first combined then sprayed or coated onto the surface of the food or pet food product.

The following examples are offered to illustrate but not limit the invention. Thus, it is presented with the understanding that various formulation modifications as well as method of delivery modifications may be made and still are within the spirit of the invention.

### Example 1

### Antioxidant Activity of Thymohydroquinone

### Materials and Methods

Materials. Canola oil, Hy-Vee brand, was purchased from Hy-Vee (Des Moines, Iowa). Chicken fat (lot 6-24-16) was obtained from Tyson (Clarksville, Ark.). Omega Protein, Inc. (Reedville, Va.) provided fish oil (Virginia Prime Gold refined Menhaden, lot HSc-11452). Monarda essential oil (Monarda fistulosa, #244 (used in the screening experiment) and #246 (used in the determination of the active molecule experiment), 25% thymoquinone) were provided by Specialty Crop Improvement. Rosemary extract (RM015425, lot 1603114407 (used in the screening experiment) and lot 1612111504 (used in the determination of the active molecule experiment, as well as the thymohydroquinone efficacy experiments) and 95% Mixed Tocopherols (RM15515, lot 1504100490, 95.57%) were used as positive controls and obtained from Kemin Animal Nutrition and Health. Thymoquinone (lot MKCB6982, 98%), carvacrol (lot 090428BJV, 98%), thymol (lot 090M0155V, 99.5%), and tert-Butylhydroquinone (lot MKBN5279V, 97%) were purchased from Aldrich (St. Louis, Mo.). Thymohydroquinone was produced by reduction of thymoquinone with zinc metal, according to a known procedure. Stolow, R. D., McDonagh, P. A., Bonaventura, M. M. J. Am. Chem. Soc. 1964, 86: 2165-2170. Dog kibble was produced at Wenger (Sabetha, Kans.).

Peroxide value measurement. Samples were analyzed for degree of oxidation over the course of the study by measuring peroxide value generation. At each testing time-point, samples were prepared in triplicate. Preparation and analysis of the samples followed the FOX II Method for Peroxide Value Quantitation (MET-11-00040). Results are expressed as meq/kg oil for all oil samples and as meq/kg kibble for kibble samples.

Aldehydes (hexanal and 2,4-decadienal) measurement. Samples were analyzed for secondary oxidation by measuring hexanal and 2,4-decadienal content. Due to limited instrument resources for this test method, single samples were prepared and analyzed according to Secondary Oxidatives by GC (MET-11-00038). Results are expressed as the sum of hexanal and 2,4-decadienal in ppm.

HPLC analysis. Monarda essential oil was weighed in triplicate (7-18 mg), the exact mass recorded, and dissolved in 5 mL of acetonitrile in a 5-mL volumetric flask. The solution was mixed using a vortex mixer before being transferred into an HPLC vial, and 1 μL was injected onto the HPLC. Standards of thymoquinone (TQ 99.0%), carvacrol (98.0%), and thymol (99.5%) were used to build standard curves. Lab-produced thymohydroquinone (THQ), ≥95% pure via NMR analysis, was used to build the THQ standard curve.

Standard solutions of thymol, carvacrol, and THQ were prepared the same way by weighing the standard (8-15 mg) and diluting to 25 mL with acetonitrile in a 25-mL volumetric flask, then a 0.1 mL aliquot was diluted to 1 mL directly in the HPLC vial, and a six-point standard curve was generated using six injection volumes (0.5, 1, 2, 5, 10, and 20 μL). Due to the intense response of TQ, 7 mg was weighed and diluted to 100 mL with acetonitrile in a 100-mL volumetric flask, then a 0.05 mL aliquot was diluted to 1 mL directly in the HPLC vial. The same injection volumes were used as for the other standard compounds. Analysis was carried out using an Agilent 1260 Infinity series HPLC with a DAD (257 and 280 nm) using a Phenomenex column (Kinetex C18, 5μ, 250×4.6 mm, 100 Å). Mobile phase A was water with 0.1% acetic acid, and mobile phase B was acetonitrile with 0.1% acetic acid. Table 1 shows the method parameters. The results of TQ, carvacrol, thymol, and THQ are expressed as percent of MEO.

TABLE 1
High Performance Liquid Chromatography method parameters
for Monarda essential oil analysis.

| Time (min) | Line A (%) | Line B (%) |
|---|---|---|
| 0.0 | 77 | 23 |
| 1.0 | 77 | 23 |
| 25.0 | 0 | 100 |
| 30.0 | 0 | 100 |
| 35.0 | 77 | 23 |

| Column temperature | 30° | C. |
|---|---|---|
| Flow rate | 1.0 | mL/min |
| Absorbance | 280 nm for thymol, carvacrol, | |
| | thymohydroquinone | |
| | 257 nm for thymoquinone | |
| Integration parameters: slope | 1 | |
| sensitivity | | |
| Peak width | 0.04 | |
| Area reject/height reject | 1/1 | |
| Detector slit | 4 | nm |

Oxidative Stability Instrument. The antioxidant activity of THQ and positive control molecules in canola and fish oils and chicken fat was measured using method KNRDM-005, Determination of oxidation rate by the Oxidative Stability Instrument. Each sample was prepared in duplicate for canola oil and in triplicate for fish oil and chicken fat. Canola oil and chicken fat samples were run at 100° C., and fish oil was run at 80° C. Results are expressed as percentage improvement over the untreated matrix.

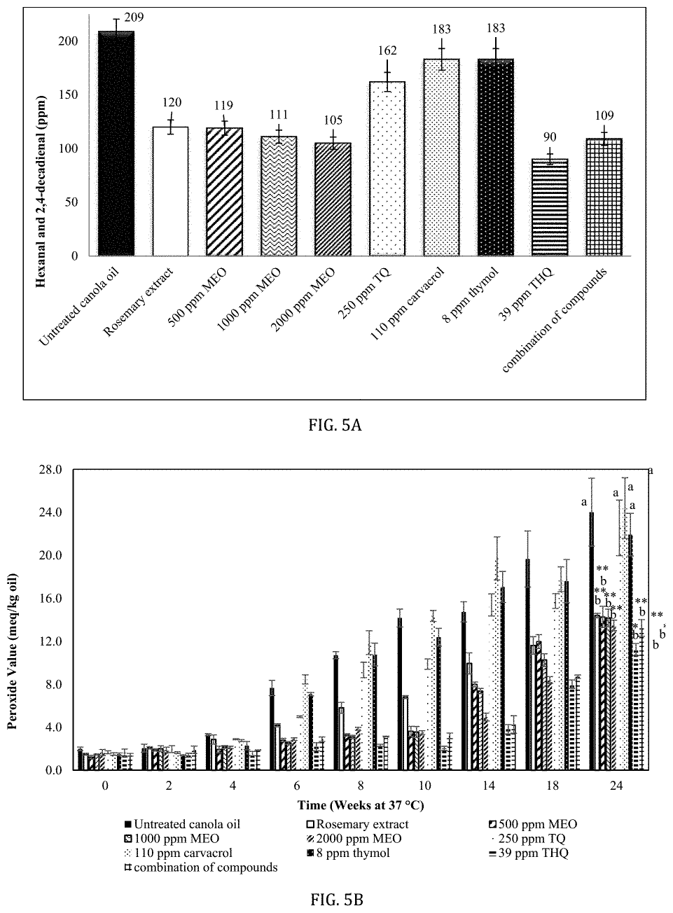

Statistical analysis. One-Way ANOVA (StatGraphics Centurion XV) was used to determine significant differences between antioxidant treatments for peroxide values and activity, measured by OSI (p<0.05). Where significant differences resulted, Multiple Range Test was used to separate the means. For FIG. 5, due to the large variation of the untreated sample, a student t-test was also performed between the THQ-treated sample and all samples that were calculated to be homogeneous using ANOVA.

Initial antioxidant screening. The initial antioxidant screening consisted of bulk oil and bulk fat studies to determine activity in each matrix. Monarda essential oil and rosemary extract was used to treat either 200 g of canola oil or 200 g of chicken fat. One replicate for each sample was prepared. An application rate of 250 ppm of the active molecule was used for each treatment. Therefore, different masses of each material were used in order to achieve the target of 250 ppm of active molecule(s) (Table 2). Untreated canola oil (200 g) and untreated chicken fat (200 g) served as the negative controls, while rosemary extract containing 10% carnosic acid was used as a positive control. Canola oil samples were stored in an incubator set at 37° C. for 20 weeks, and chicken fat samples were stored in an incubator set at 50° C. for 24 weeks. The samples were tested for peroxide values and aldehydes.

TABLE 2
Preparation of samples for bulk oil and fat studies.

| | Amount of | Application | |
|---|---|---|---|
| Treatment | material added | of actives | |
| (material) | (g) | (ppm) | Known actives |
| Untreated matrix | — | 0 | — |
| Rosemary extract | 0.500 | 250 | 10% carnosic acid |
| Monarda essential | 0.200 | 250 | 25% thymoquinone |
| oil | | | |

Determination of the active molecule in Monarda essential oil (MEO). Constituents of MEO, namely TQ, carvacrol, thymol, and THQ were applied to the oil at a rate corresponding to their amount in MEO (Table 3). Additionally, 500, 1000, and 2000 ppm MEO concentrations were included to determine if a dose response exists. The 1000 ppm concentration is the concentration that was compared with the individual compounds, as well as the combination of compounds. Furthermore, the four active compounds (TQ, carvacrol, thymol, and THQ) were combined in canola oil and tested at the same ratio and concentrations as the respective individual compounds. The chemical structures of these four compounds are shown in FIG. 1. Untreated canola oil (200 g) served as the negative control, while rosemary extract served as the positive control. One 200 g replicate for each sample was prepared. The canola oil samples were stored in an incubator set at 37° C. for 24 weeks. Oxidation of the oil samples was measured by hydroperoxide and aldehydes accumulation.

TABLE 3
Preparation of samples for the bulk canola oil study.

| | Amount of | | Percent of |
|---|---|---|---|
| | material | Application | compound in |
| Treatment | added | of actives | Monarda |
| (material or compound) | (g) | (ppm) | essential oil |
| Untreated matrix | — | 0 | — |
| Rosemary extract | 0.500 | 250 | NA |
| Monarda essential oil | 0.100 | 500 ppm MEO | NA |
| Monarda essential oil | 0.200 | 1000 ppm MEO | NA |
| Monarda essential oil | 0.400 | 2000 ppm MEO | NA |
| Thymoquinone | 0.050 | 250 | 25 |
| Carvacrol | 0.022 | 110 | 11 |
| Thymol | 1.6 mg | 8 | 0.8 |
| Thymohydroquinone | 7.8 mg | 39 | 3.9 |
| Combination of four | | Same application | |
| MEO compounds | | as above for | |
| | | each compound | |

MEO: Monarda essential oil, Rosemary extract contains 10% carnosic acid.

Antioxidant activity of thymohydroquinone compared with tert-butylhydroquinone in oils, fat, and on the surface of kibble. Antioxidant activity of the molecules in canola oil, fish oil, and chicken fat was measured using Oxidative Stability Instrument (OSI). Specifically, THQ was tested at three application levels (50, 250, and 500 ppm) to determine if a dose response exists. The positive control molecules, TBHQ and carnosic acid, were included at an application rate of 250 ppm. To achieve 250 ppm of carnosic acid, an application rate of 2500 ppm of rosemary extract was used. For chicken fat, TBHQ and carnosic acid were still used as positive controls with the addition of 95% mixed tocopherols. For the kibble surface treatment study, treated canola oil was coated onto the surface of kibble (dog diet, high meat inclusion with 23.5% chicken slurry addition) at 7% application. Carnosic acid (rosemary extract) and TBHQ were again used as positive controls at 250 ppm. Thymohydroquinone was applied at 50, 250, and 500 ppm. Table 4 shows the application rates of each compound used for each matrix.

TABLE 4
Control molecules and application rates used for canola
oil, fish oil, chicken fat, and kibble studies.

| | | Application | |
|---|---|---|---|
| | | rate of the | Antioxidant |
| | | active molecule | activity |
| Matrix | Molecules tested | (ppm) | test methods |
| Canola | None (untreated control) | 0 | OSI |
| oil | THQ | 50, 250, 500 | |
| | TBHQ (positive control) | 250 | |
| | Carnosic acid (positive control) | 250 | |
| Fish oil | None (untreated control) | 0 | |
| | THQ | 50, 250, 500 | |
| | TBHQ (positive control) | 250 | |
| | Carnosic acid (positive control) | 250 | |
| Chicken | None (untreated control) | 0 | |
| fat | THQ | 50, 250, 500 | |
| | TBHQ (positive control) | 250 | |
| | Carnosic acid (positive control) | 250 | |
| | 95% mixed tocopherols (positive | 250 | |
| | control) | | |
| Kibble | None (untreated canola oil) | 0 | PV, |
| | THQ | 50, 250, 500 | aldehydes |
| | TBHQ (positive control) | 250 | |
| | Carnosic acid (positive control) | 250 | |

THQ: thymohydroquinone,
TBHQ: tert-butylhydroquinone,
OSI: Oxidative Stability Instrument,
PV: peroxide values

Kibble was coated in-house, lab-scale (1 kg) according to the procedure for coating kibble (310-KNRD-017). The coated kibble was stored in an incubator set at 40° C. for 16 weeks, and oxidation of the kibble samples was measured by the peroxide value method and hexanal and 2,4-decadienal accumulation.

### Results

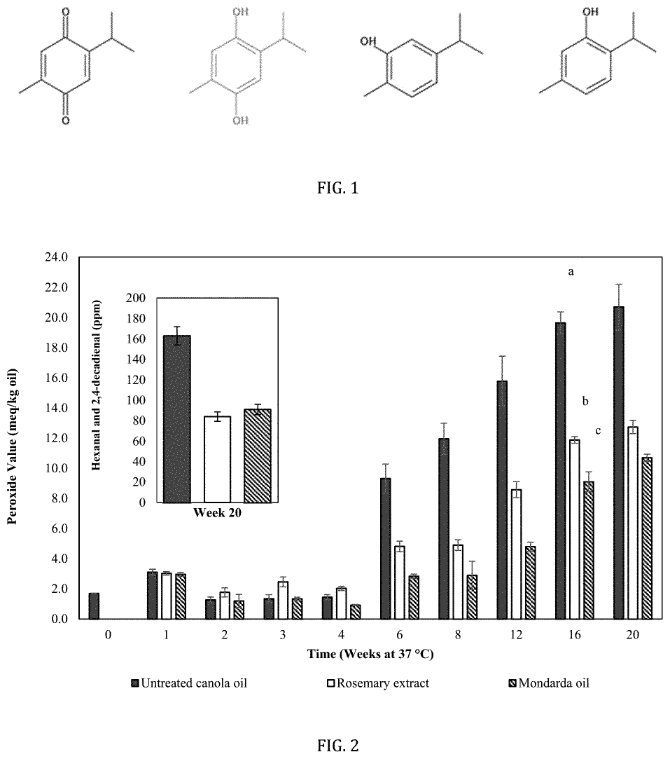

Initial antioxidant screening. The initial antioxidant screening results (FIG. 2) showed that MEO performed especially well in canola oil. Throughout the study, MEO had lower peroxide values than and similar aldehyde content to the positive control, rosemary extract.

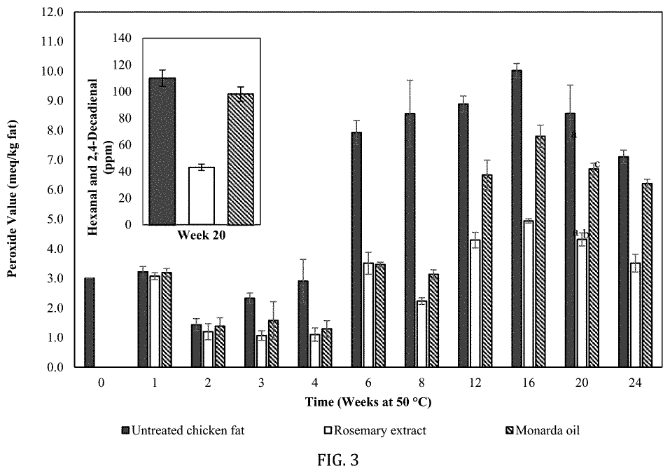

In the chicken fat matrix, the stand out antioxidant performance of MEO that was seen in canola oil was not evident. Monarda essential oil had equivalent peroxide values to rosemary extract until week 8, then rosemary extract had the lowest peroxide values (FIG. 3). Rosemary extract-treated fat (positive control) had total aldehyde content that was less than half the value of the MEO (FIG. 3).

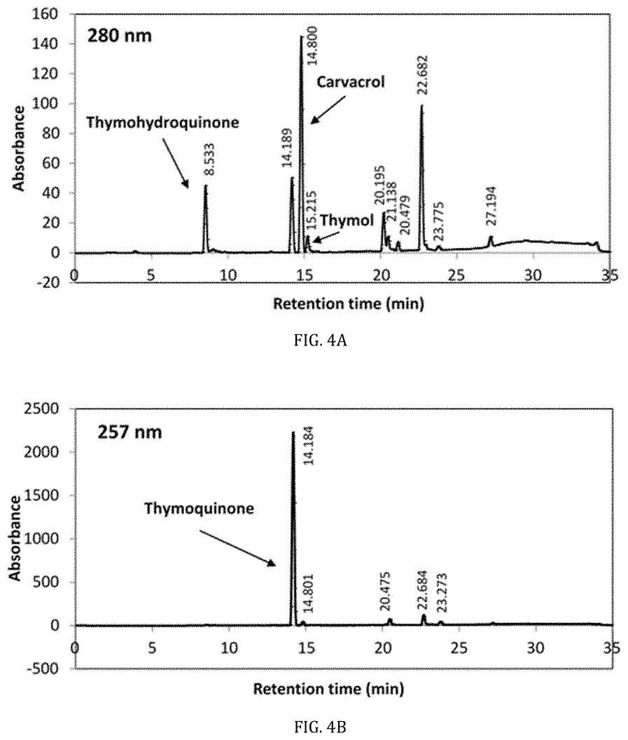

Composition of Monarda essential oil. Analysis of MEO by HPLC revealed that MEO contained 25% TQ, 11% carvacrol, and 0.8% thymol, all compounds previously known to be in MEO. Additionally, we found that this MEO sample contained 3.9% THQ (FIG. 4).

Determination of the active molecule in Monarda essential oil. Constituents of MEO, namely TQ carvacrol, thymol, and THQ, were tested for antioxidant activity in bulk canola oil when applied at a rate corresponding to their amount in the MEO. FIG. 5 shows peroxide values throughout the study and hexanal and 2,4-decadienal content at the final testing point, week 24. For peroxide value measurement, Monarda essential oil samples, at all doses, were performing better than the rosemary extract control until week 14. A dose response was seen at weeks 14 and 18. However, by the final testing point, there was not a dose response for MEO, and MEO had the same peroxide values as rosemary extract. A slight dose response was present in aldehydes between the 500 and 2000 ppm MEO samples. At week 24, the addition of TQ carvacrol, and thymol all had no effect. For the duration of the study, the only individual compound that performed better than the MEO-treated canola oil was THQ. Throughout the study and at the final testing point, THQ applied at 39 ppm had lower peroxide values and a lower summed hexanal and 2,4-decadienal value than the positive control molecule, carnosic acid, applied at 250 ppm (by application of 2500 ppm rosemary extract). The combination of TQ, carvacrol, thymol, and THQ had the same activity as the “equivalent” 1000 ppm MEO sample.

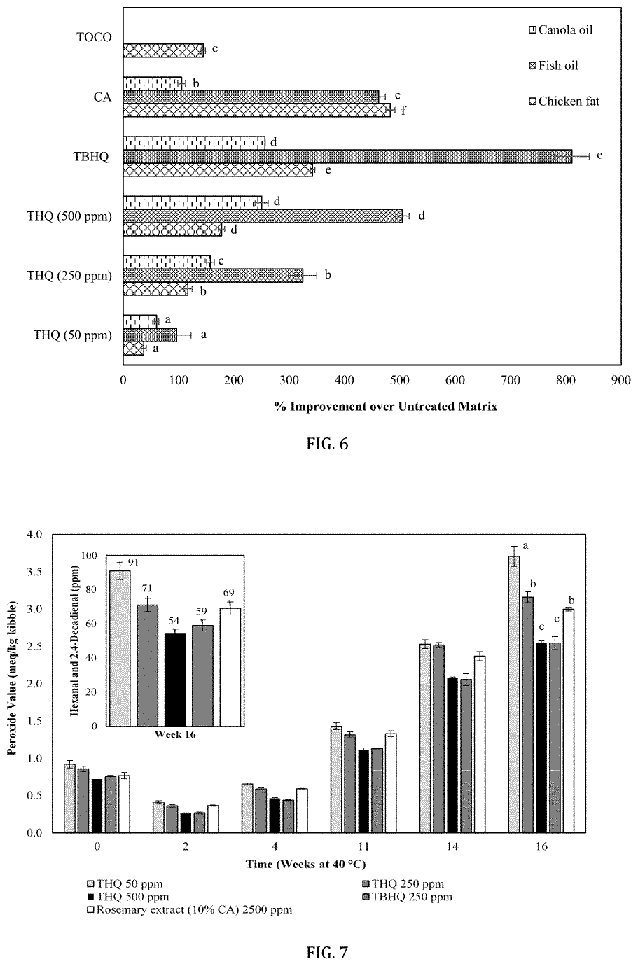

Antioxidant activity of thymohydroquinone compared with tert-butylhydroquinone in oils, fat, and on the surface of kibble. FIG. 6 shows OSI results in each matrix. A clear dose response for THQ was observed, with a higher application rate corresponding to greater activity. Antioxidant activity results of the different molecules were dependent upon the matrix. Results are expressed as percentage improvement over the untreated matrix. When comparing THQ's activity to the other antioxidant molecules, THQ had the best performance in canola oil, where THQ at 250 ppm provided greater activity than CA at the same application rate, and THQ at 500 ppm had the same activity as TBHQ at 250 ppm. When comparing which matrix THQ provided the greatest percent improvement, THQ performed the best in fish oil, providing 100% improvement over untreated fish oil at a 50 ppm application rate and up to 500% improvement when 500 ppm was applied. Unlike in canola oil, in fish oil, THQ at 250 ppm had less activity than CA. However, when a double application rate was used, THQ had greater activity than CA. No amount of THQ tested was able to match the activity of TBHQ. In chicken fat, THQ's activity was similar to that of tocopherols. Carnosic acid had the highest antioxidant activity, followed by TBHQ. No level of THQ tested performed as well as TBHQ.

As depicted in FIG. 7, the researchers measured peroxide values and aldehyde content of the kibble containing THQ, TBHQ, and CA applied to the canola oil coated on its surface. A dose response was observed for the THQ treatment, as higher amount of THQ used resulted in lower peroxide values of the kibble. THQ used at 250 ppm had equivalent activity to carnosic acid used at the same level. Thymohydroquinone, when applied at 500 ppm, provided antioxidant activity equivalent to 250 ppm TBHQ.

Discussion. An antioxidant activity screening study was performed, where Monarda essential oil was evaluated. In this study it was revealed that, in canola oil, MEO possesses exceptional antioxidant activity, even higher than that of rosemary extract.

Due to the promising results of MEO in the initial screening experiment, a study was designed to examine the individual compounds in MEO to determine what compound or compounds are responsible for its antioxidant activity. It is known that MEO contains a high amount of TQ as well as carvacrol and thymol. In an oil or fat matrix, it is unlikely that TQ, without an OH-group, is responsible for the antioxidant activity, and previous Nutrisurance studies showed no activity from carvacrol or thymol (data not shown). Therefore, High Performance Liquid Chromatography (HPLC) was employed to determine not only which molecules were present in MEO, but also at what levels, in order to treat canola oil with the individual compounds at the concentration they are found in MEO. As expected, it was found that MEO contained 25% TQ 11% carvacrol, and 0.8% thymol. Additionally, several other peaks were observed in the chromatogram (8.5, 20.2, and 22.7 min retention time). One of the peaks (8.5 min) was identified as THQ by comparison of the retention time to that of a compound synthesized in our laboratory. The researchers hypothesized that the THQ was responsible for the observed antioxidant activity of MEO, due to its polyphenolic structure. Other peaks present in the MEO chromatogram were not identified.

To confirm the hypothesis that THQ was the active molecule in MEO, thymoquinone, carvacrol, thymol, as well as THQ were tested individually and in combination for antioxidant activity. The results showed that, indeed, only THQ showed activity in canola oil. Moreover, the combination of the four known compounds provided the same activity as MEO. It is worth noting that 39 ppm of THQ applied to canola oil provided greater antioxidant activity than rosemary extract which was used at 2500 ppm, in order to deliver 250 ppm of carnosic acid.

Additional studies focused on activity of pure THQ, obtained by a synthetic route, in unsaturated oils and applied to the kibble matrix. Thymohydroquinone possesses two hydroxyl groups in the para position, which could serve as hydrogen atom donors to the lipid derived radicals, hence providing strong antioxidant activity. A similar molecule, TBHQ a synthetic antioxidant with two para hydroxyl groups is a well-known antioxidant for unsaturated oils. Therefore, the researchers compared the activity of THQ to that of TBHQ in several matrices. The researchers found that, even though it possesses strong antioxidant activity, THQ is less active than TBHQ. The extent of activity reduction was dependent on the matrix. Specifically, when tested in fish oil and chicken fat, THQ showed a 2.5-3-fold decrease in activity compared to TBHQ, used at the same application rate. In canola oil, bulk or applied to the kibble surface, the difference between THQ and TBHQ was 1.6-2-fold.

### Example 2

### Antioxidant Activity of Thymohydroquinone in Combination with Tocopherols and Rosemary Extract when Used in Pet Food

Materials. Monarda essential oil (6.1% THQ other components: 24.0% thymol, 14.4% TQ, and 0.9% carvacrol), tocopherols, and rosemary extract (10% carnosic acid) and their combinations were applied to chicken fat, which was then coated onto chicken and rice dog diet at 4%. Composition of the diet was as follows: rice (24%), chicken meal (15%), chicken slurry (15%), pea protein (7%), fish meal (6.5%), lamb meal (6.25%), rice bran (6%), flaxseed (5.2%), beet pulp (4.6%), oat groats (3%), sunflower oil (1.75%), vitamins and minerals (1.7%), and chicken fat (coated at 4%). The kibble core before extrusion was treated with tocopherols (NATUROX Plus Dry®). The sum of actives (THQ tocopherols, and carnosic acid) delivered to the finished kibble was 55 ppm for each treatment (Table 5). Untreated chicken fat was used as a negative control. Finished kibble was stored at 40° C. and ambient temperature and tested for peroxide values periodically.

TABLE 5
Actives tested in the chicken and rice dog diet.

| | THQ | Tocopherols | Carnosic acid |
|---|---|---|---|
| Variable | (ppm) | (ppm) | (ppm) |
| 1 (M) | 55 | — | — |
| 2 (T) | — | 55 | — |
| 3 (R) | — | — | 55 |
| 4 (M T) | 27.5 | 27.5 | — |
| 5 (M R) | 27.5 | — | 27.5 |
| 6 (T R) | — | 27.5 | 27.5 |
| 7 (M T R) | 18.3 | 18.3 | 18.3 |
| 8 (M T R) | 18.3 | 18.3 | 18.3 |

M—monarda extract,
T—tocopherols,
R—rosemary extract

Statistical analysis. One-Way ANOVA (StatGraphics Centurion XV) was used to determine significant differences between antioxidant treatments for peroxide values (p<0.05). Where significant differences resulted, Multiple Range Test was used to separate the means.

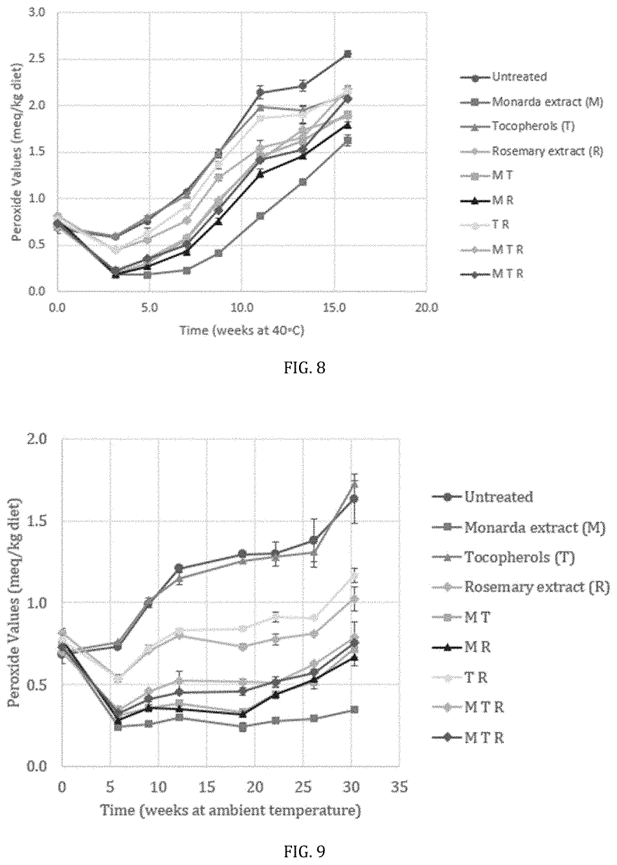

Results. When stored at 40° C., the untreated kibble variable reached peroxide value of 2.5 meq/kg after 15 weeks, while peroxide values for antioxidant treatment variables were significantly lower with 1.6, 2.1, 2.2 meq/kg for monarda extract, tocopherols, and rosemary extract, respectively. Among the combinations of antioxidants, M R resulted in the lowest peroxide values (1.8 meq/kg) followed by M T (1.9 meq/kg), MTR (2.0 meq/kg) and T R (2.2 meq/kg) (FIG. 8, Table 6).

TABLE 6
ANOVA for peroxide values for kibble stored at 40° C.

| | Mean PV day 16 | Homogeneous |
|---|---|---|
| Variable | (meq/kg diet) | Groups |
| Monarda extract (M) | 1.622 | a |
| M R | 1.794 | b |
| M T | 1.908 | c |
| M T R | 1.977 | c |
| Tocopherols (T) | 2.109 | d |
| T R | 2.153 | d |
| Rosemary extract (R) | 2.176 | d |
| Untreated | 2.554 | e |

PV—peroxide values,
M—monarda extract,
T—tocopherols,
R—rosemary extract

When stored under ambient conditions, the untreated kibble variable reached peroxide value of 1.6 meq/kg after 30 weeks, while peroxide values for monarda and rosemary extract treatment variables were significantly lower with 0.3 and 1.9 meq/kg, respectively. However, peroxide value for tocopherol-treated variable was not statistically different than the untreated control. Among the combinations of antioxidants, MR, MT and MTR resulted in the lowest peroxide values (0.7-0.8 meq/kg), followed by TR (1.2 meq/kg) (FIG. 9, Table 7).

In summary, the above results show that monarda extract can be used as an antioxidant for pet food, either alone or in combinations with tocopherols or rosemary extract, as it improves the oxidative stability of the pet food.

TABLE 7
ANOVA for peroxide values for kibble
stored under ambient conditions.

| | Mean PV day 30 | Homogeneous |
|---|---|---|
| Variable | (meq/kg diet) | Groups |
| Monarda extract (M) | 0.348 | a |
| M R | 0.667 | b |
| M T | 0.719 | b |
| M T R | 0.772 | b |
| Rosemary extract (R) | 1.024 | c |
| T R | 1.167 | d |
| Untreated | 1.633 | e |
| Tocopherols (T) | 1.723 | e |

M—monarda extract,
T—tocopherols,
R—rosemary extract

### Example 3

### Antioxidant Activity of Thymohydroquinone in Combination with Tocopherols and Rosemary Extract Applied to Menhaden Fish Meal

Materials. As summarized in Table 8, Formula 1 consisted of tocopherols and rosemary extract (10% carnosic acid) in soybean oil. Formula 2 consisted of rosemary extract (10% carnosic acid), Monarda essential oil (5.7% THQ, other components: 7.9% thymol, 15.0% TQ, and 0.7% carvacrol), and tocopherols in soybean oil. Formula 1 and Formula 2 were applied to untreated Menhaden fish meal at the production site. The fish meal composition included: protein (69.2%), fat (7.4%), moisture (6.6%), ash (20.7%), sulfur (0.8%), phosphorus (3.5%), potassium (0.9%), magnesium (0.2%), calcium (5.9%), sodium (0.7%), iron (54 ppm), manganese (33 ppm), copper (4 ppm), and zinc (112 ppm). Untreated fish meal was used as a negative control. All fish meal samples (untreated, treated with Formula 1, treated with Formula 2) were stored at ambient lab temperature (approx. 21° C.) and tested for peroxide values periodically.

TABLE 8
Active compounds delivered to Menhaden fish meal
with application of Formula 1 or Formula 2.

| | THQ | Tocopherols | Carnosic acid |
|---|---|---|---|
| Variable | (ppm) | (ppm) | (ppm) |
| Formula 1(T R) | — | 304 | 39 |
| Formula 2 (M T R) | 28 | 23 | 88 |

M—monarda extract,
T—tocopherols,
R—rosemary extract

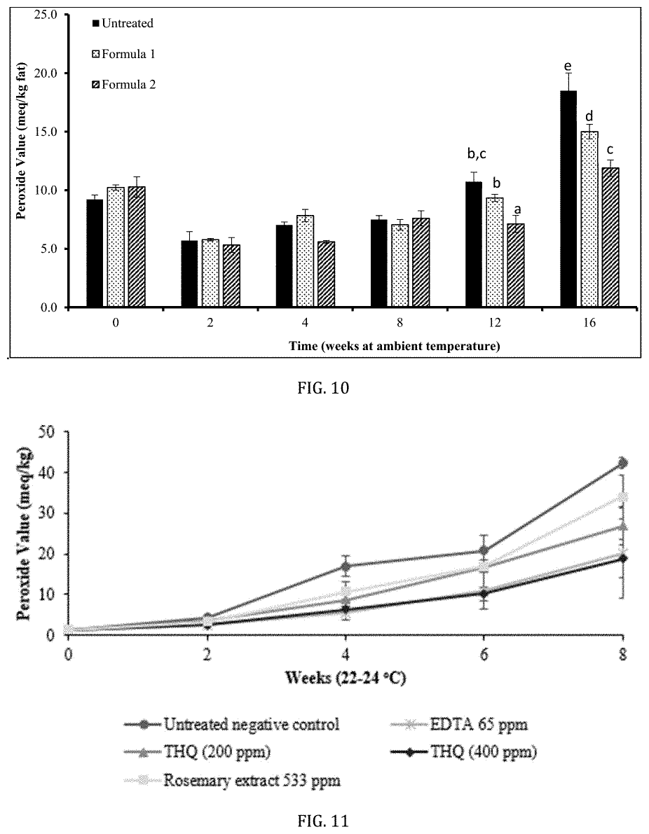

Results. When stored at ambient lab temperature, the fish meal treated with Formula 2 had statistically lower peroxide values than the fish meal treated with Formula 1 and the untreated fish meal at weeks 12 and 16 (FIG. 10). After 16 weeks, the untreated fish meal had a peroxide value of 18.50±1.51 meq/Kg fat and the treated fish meals had peroxide values of 15.00±0.63 and 11.90±0.72 meq/Kg fat for treatment with Formula 1 and Formula 2, respectively

In summary, the monarda extract containing THQ can be used as an antioxidant for fish meal, in combination with tocopherols and rosemary extract, as evidenced by a formula containing monarda extract in combination with tocopherols and rosemary extract inhibited oxidation in fish meal compared with untreated fish meal and provided greater antioxidant activity than a formula containing tocopherols and rosemary extract without the addition of monarda extract.

### Example 4

### Antioxidant Performance of THQ in Human Foods

1. THQ Performance in Food Emulsions Using Mayonnaise as an Example

Objective—To evaluate the performance of THQ in mayonnaise, a typical food matrix that represent food emulsions, and compare to other common antioxidants that are known to protect mayo from oxidation. In the food industry, EDTA is considered the “gold standard” and used in mayo, dressing and sauce. However, there are drawbacks to EDTA. For instance, for regulatory reasons, the dosage of EDTA is limited. One alternative is rosemary extract, which is a common natural plant extract that has been commercialized for food emulsion, and used for the comparison as another representative natural plant extract.

Materials. Table 9 summarizes the materials used throughout the experiment. THQ is prepared in-house. Rosemary extract used in this study was ROSAN 8CA LC Liquid (Kemin Industries, Des Moines, Iowa), which is the liquid base for downstream formulation. However, in the report, it was converted into a commercial rosemary product FORTIUM® R30 Liquid (Kemin Industries, Des Moines, Iowa), and dosage normalized to the same amounts of active compounds.

TABLE 9
Materials used throughout the experiment.

| Ingredient | Manufacturer | Category # | Lot # |
|---|---|---|---|
| Deionized water | Fisher Scientific | W220 | |
| Granulated sugar | Market Pantry | N/A | N/A |
| Heinz vinegar (5%) | Heinz | N/A | N/A |
| Mustard flour | Tones | N/A | N/A |
| Egg yolk (frozen | Oskaloosa Food | A-899 | 038V4 |
| 10% salt) | Products Corp | | |
| Soybean oil | KANA | RM01320 | 1601108414 |
| Salt | Cargill | N/A | N/A |
| EDTA | Premium Ingredient | 30309 | C060131 |
| | International | | |

Mayonnaise screening study. Mayonnaise was made in-house (Table 10). Egg yolk was added to the bowl of a Kitchen Aid mixer (Artisan model, St Joseph, Mich.) and whipped with the wire whisk attachment for 30 seconds on setting #2. Salt, mustard, and sugar were added and mixed for 1 min on setting #4 and the bowl was scraped with a spatula every 20 seconds. Vinegar and water were combined and ½ of the liquid was added to the egg mixture. The contents were mixed for 30 seconds on setting #2, the bowl was scraped, then mixed 30 seconds on setting #4, and the bowl was scraped again. Next, the oil was added at a pipet full at a time (about 2 mL) on setting #4 to allow the oil to absorb into the eggs. The oil was added slowly over the course of 20 min. At the 10 min mark, ¼ of the remaining water/vinegar mixture was added. At the end of the 20 minutes, the remaining ¼ of the water/vinegar mixture was added.

TABLE 10
Mayonnaise formulation.

| Ingredient | Weight % |
|---|---|
| Salt | 0.61% |
| Heinz Vinegar (5% Acetic acid) | 12.60% |
| Mustard flour | 1.00% |
| Egg yolk (10% salt) | 8.89% |
| Water | 1.90% |
| Soybean oil | 75.00% |

Ingredient screening for antioxidant capabilities in mayonnaise. Table 11 contains the ingredients subject for the storage study and the dosages. EDTA was used at 65 ppm, which was a standard dosage for the mayonnaise and dressing industry. Rosemary extract dosage was determined based on previous study recommendations. THQ was tested at two levels for information on dose response. Peroxide values, which represent the primary oxidative byproducts, and have correlation with the oxidative shelf life of mayonnaise, were monitored every two weeks for a total of eight weeks at room temperature (22-24° C.) following standard lab procedures.

TABLE 11
Treatment in the mayonnaise study. The dosage is based
on total weight of the mayonnaise. Rosemary extract =
FORTIUM R30 Liquid (Kemin Industries, Inc. Des Moines, IA)

| Treatment | Dosage (ppm) |
|---|---|
| Untreated negative control | 0 |
| THQ | 200 |
| THQ | 400 |
| Rosemary extract | 533 |
| EDTA | 65 |

Results. The oxidative byproducts generation is summarized in FIG. 11. There was a dose response for THQ that higher dosage of THQ (400 ppm) was able to match EDTA performance. Rosemary extract was able to improve the oxidative stability comparing to the untreated negative control but was not able to match the performance of EDTA, and inferior to THQ at lower dosages of its own.

To the inventors' knowledge, this represents the first time that a natural compound was found to be able to match EDTA performance in delaying peroxides generation. Previously, rosemary extract, spearmint extract and green tea extract were identified as promising ingredients for the improvement of oxidative stability of mayonnaise, and their combinations were developed as a powerful antioxidant system. However, it was found in this study that a single chemical compound could perform to the desired efficacy at a moderate dosage.

2. THQ Performance in Food Emulsions Using Ranch Dressing as the Model Food System

Objective—To evaluate the performance of THQ and its combinations with other known antioxidants/plant extracts in ranch dressing, the most popular dressing type in the United States, and provide clean label ingredients with better efficacy to delay flavor loss and lipid oxidation.

Materials and methods. Table 12 contains the recipe for the ranch dressing. The dressing was made by blending the ingredients in a bowl with an immersion blender. THQ was prepared in-house from Monarda fistulosa essential oil which had approximately 30% thymoquinone and after purification, reached a purity of >95% THQ. The rosemary extract used in this study was ROSAN 8CA LC Liquid, which is the rosemary liquid base for downstream formulation. FORTRA 101 Dry is a spearmint extract-based natural plant extract product, with rosmarinic acid as its active compound (5% rosmarinic acid). Previous experiments revealed that THQ successfully delayed lipid oxidation in mayonnaise. In this study, THQ was evaluated by itself, as well as in combination with the two plant extracts for the evaluation of synergistic interactions.

The study design is listed in Table 13. One negative control and two positive controls were included. The negative control was devoid of any antioxidants. EDTA was used as one positive control while NaturFORT™ RSGT 101 Dry, the plant extract blend of spearmint extract, rosemary extract and green tea extract, was used as a clean label positive control. This product was commercialized for its efficacy in slowing down lipid oxidation. The new study with THQ would hopefully yield antioxidant blends that were more effective than the clean label positive control. A total of 33 treatment groups were evaluated. The dressing was stored at ambient temperature (22-24° C.) under regular lab light settings (off at night and on during daytime). Only one replicate was performed due to the number of treatments. Sensory evaluation was not performed at this screening stage. Peroxide values (PV) were measured following existing SOP.

Statistical analysis was performed in StatGraphics Centurion XI package. The independent variables included the ppm dosages of THQ, ROSAN SF 8CA LC and FORTRA 101 (spearmint extract). The factor for analysis was the peroxide value at the last data point. The effect from each individual ingredient, standard pareto chart and analysis of variance (ANOVA) was calculated and plotted by the software, with default α=0.05.

TABLE 12
Ranch dressing formulation

| Ingredient | % w/w |
|---|---|
| Water | 42.61 |
| Potassium sorbate | 0.10 |
| Lemon juice concentrate | 0.30 |
| Buttermilk powder | 3.00 |
| Sugar | 3.00 |
| 10% salted egg yolk | 3.40 |
| Garlic powder | 0.50 |
| Onion powder | 0.25 |
| Black pepper | 0.10 |
| Dill weed | 0.05 |
| Chopped chives | 0.10 |
| Xanthan gum | 0.35 |
| Modified food starch | 0.4 |
| Salt | 1.4 |
| Phosphoric acid | 0.27 |
| Distilled vinegar (150 grains) | 2.17 |
| Soybean oil | 42.00 |

TABLE 13
Treatments used in the ranch salad dressing. THQ =
pure thymohydroquinone compound, RSGT = NaturFORT
RSGT 101 Dry; R = ROSAN SF 8CA LC Liquid; SP =
FORTRA 101 Dry. All the values use the unit of parts
per million (ppm) based on dressing weight.

| No. | Treatment |
|---|---|
| 1 | Untreated |
| 2 | EDTA 65 ppm - positive 1 |
| 3 | RSGT 1500 ppm - positive 2 |
| 4 | THQ 100 pm |
| 5 | THQ 300 pm |
| 6 | THQ 500 pm |
| 7 | THQ/R/SP = 100/50/500 |
| 8 | THQ/R/SP = 100/50/300 |
| 9 | THQ/R/SP = 100/50/100 |
| 10 | THQ/R/SP = 100/175/100 |
| 11 | THQ/R/SP = 100/175/300 |
| 12 | THQ/R/SP = 100/175/500 |
| 13 | THQ/R/SP = 100/300/300 |
| 14 | THQ/R/SP = 100/300/500 |
| 15 | THQ/R/SP = 100/300/100 |
| 16 | THQ/R/SP = 300/50/300 |
| 17 | THQ/R/SP = 300/50/500 |
| 18 | THQ/R/SP = 300/50/100 |
| 19 | THQ/R/SP = 300/175/100 |
| 20 | THQ/R/SP = 300/175/300 |
| 21 | THQ/R/SP = 300/175/500 |
| 22 | THQ/R/SP = 300/300/500 |
| 23 | THQ/R/SP = 300/300/300 |
| 24 | THQ/R/SP = 300/300/100 |
| 25 | THQ/R/SP = 500/50/100 |
| 26 | THQ/R/SP = 500/50/500 |
| 27 | THQ/R/SP = 500/50/300 |
| 28 | THQ/R/SP = 500/175/500 |
| 29 | THQ/R/SP = 500/175/100 |
| 30 | THQ/R/SP = 500/175/300 |
| 31 | THQ/R/SP = 500/300/100 |
| 32 | THQ/R/SP = 500/300/300 |
| 33 | THQ/R/SP = 500/300/500 |

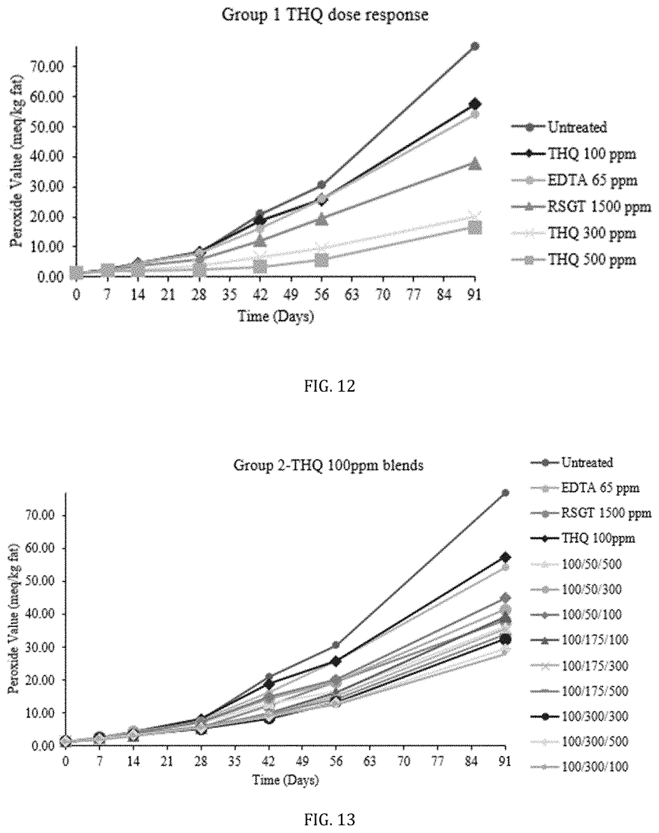

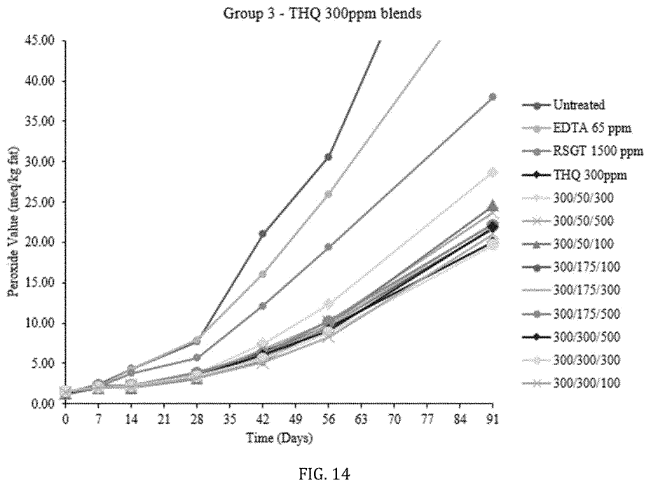

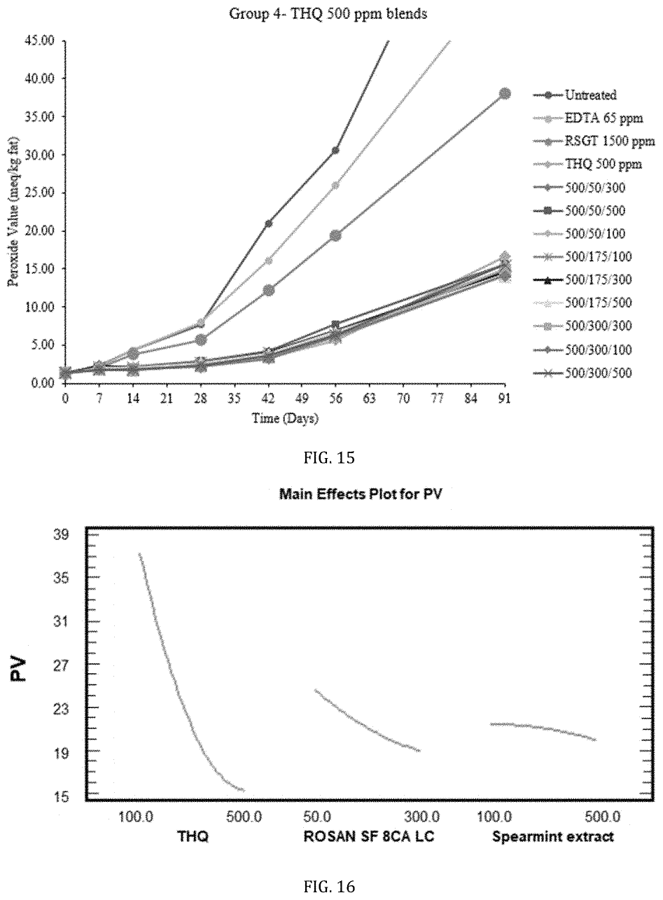

Results. Due to the large number of treatment groups, the peroxide analysis results were displayed as four separate groups based on THQ dosages. Group 1 summarized the dose response result of THQ (FIG. 12). Group 2 showed peroxide value results in treatments that included 100 ppm THQ (FIG. 13). Group 3 results summarized treatment groups that contained 300 ppm THQ and group 4 had the results of the treatment with 500 ppm (FIGS. 14-15).

As shown in FIG. 12, the researchers found that there was a dose response effect of THQ in the peroxide value results. Higher amounts of THQ resulted in lower peroxide values. The efficacy increase from 300 to 500 ppm, however, was relatively smaller comparing to the improvement from 100 ppm to 300 ppm, indicating that the efficacy might hit a plateau once the dosage increases further. The hypothesis was also supported by the main effects plot. When examining group 2-4 results (FIGS. 13-15), higher amount of THQ treatments in general resulted in lower peroxide values, regardless of the types of combinations. For example, treatments in the 100 ppm THQ group had a PV spread between 20-50 meg/kg for the last data point, while in the 500 ppm THQ group, the PV spread was more narrow and lower, between 15-18 meq/kg. The efficacy was largely driven by the amount of THQ in the combinations, which was also supported by the main effects plot in FIG. 16.

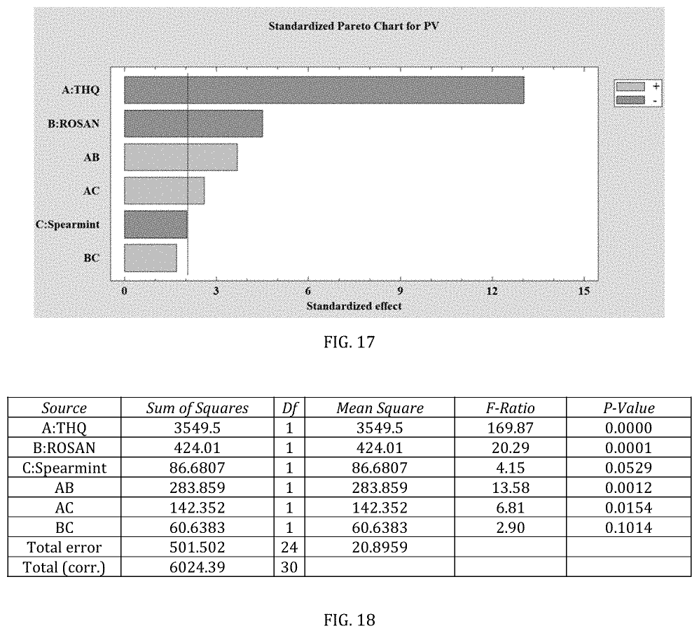

In this study, antagonistic effects were identified among the three plant extracts as antioxidant in dressing, which was unanticipated. Both the Pareto chart (FIG. 17) and ANOVA (FIG. 18) show the impact and interaction of the treatments. The rosemary extract and spearmint extract provided additive or synergistic effects in combination with THQ. The researchers observed that THQ combined with rosemary extract (as combination of AB in FIG. 17), and THQ combined with spearmint extract (as AC in FIG. 17) had a statistically significant impact when the extracts were used in combination.

3. THQ in Delaying Lipid Oxidation in Bulk Oil

Objective—Understanding the efficacy of TQ and THQ in bulk oils for oxidative stability improvement, and to identify whether THQ or TQ form synergistic or additive pairs with other known antioxidants/plant extracts.

Materials and methods. Thymoquinone (TQ), when used in the study as pure compound, was purchased from Sigma-Aldrich. Thymohydroquinone (THQ), when used as a pure compound, was prepared from known methods. THQ containing Monarda extract was prepared using TQ containing Monarda leaf. Ascorbic acid is the pure compound and is KFT raw material. EN-HANCE® A103 or A103S are both KFT products that contain 20% TBHQ and 3% citric acid. TBHQ is the gold standard antioxidant for bulk vegetable oils and is made from synthetic chemistry. Its legal limit is 200 ppm based on oil weight. FORTIUM® R30 Liquid (R30) is a KFT commercial rosemary extract product that uses sunflower oil to disperse rosemary extract. GT-FORT™ 101 C IP Liquid (GT-FORT) is a KFT commercial oil soluble green tea extract based product that uses IP canola oil as the liquid carrier.

General methods for oxidation monitoring in bulk oil. Peroxides measurement followed previously published FOX II method for peroxide value quantitation. Gas chromatography (GC) coupled with a flame ionization detector (GC-FID) was used to quantify the amount of hexanal in the oil sample following previously established method. Oxidative stability index (OSI) was obtained following established methods. Protection factor is defined as the ratio of OSI hours for treated oils and untreated oils.

Synergy of TQ and ascorbic acid in soybean oil. Each treatment (Table 14) was blended for 40 g total amount of soybean oil and transferred to a clear glass jar with a black closure (8 oz, Qorpak, #271012). The glass containers were capped tightly for 60° C. storage condition in dark. At each designed testing point, a small amount of sample (˜2 g) was retrieved and analyzed for primary oxidative byproducts (peroxides). Sample was collected on Day 0, 7, 10, 14, 21, 28.

TABLE 14
Treatment in soybean oil for the study
of synergy between TQ and ascorbic acid

| Sample | |
|---|---|
| # | Treatment |
| A | Untreated |
| B | EH-HANCE A103S 1000 ppm (TBHQ 200 ppm) |
| C | THQ 100 ppm |
| D | TQ 100 ppm |
| E | Ascorbic acid 390 ppm |
| F | TQ 100 ppm + Ascorbic acid 390 ppm |

Synergy of THQ and ascorbic acid in soybean oil. Each treatment (Table 15) was blended for 40 g total amount of soybean oil. The treated oil and negative control were evaluated on OSI at 110° C. OSI hours were obtained and converted into protection factor for comparison. Untreated negative control would have a protection factor of 1.0.

TABLE 15
Treatment in soybean oil for the study of
synergy between THQ and ascorbic acid

| Sample | |
|---|---|
| # | Treatment |
| A | Untreated |
| B | EH-HANCE A103S 1000 ppm (TBHQ 200 ppm) |
| C | THQ 100 ppm |
| D | THQ 200 ppm |
| E | Ascorbic acid 390 ppm |
| F | THQ 100 ppm + Ascorbic acid 390 ppm |
| G | THQ 200 ppm + Ascorbic acid 390 ppm |

Synergy of THQ and rosemary extract in soybean oil. Each treatment (Table 16) was blended for 40 g total amount of soybean oil and transferred to a clear glass jar with a black closure (8 oz, Qorpak, #271012). The glass containers were capped tightly for 60° C. storage condition in dark. At each designed testing point, a small amount of sample (˜2 g) was retrieved and analyzed for primary oxidative byproducts (peroxides) and secondary oxidative byproducts (hexanal). Sample was collected on Day 0, 7, 10, 14, 21, 28. In this study, instead of using pure compound THQ Monarda extract that contains THQ was used. The Monarda extract which contained 26% THQ was dissolved in propylene glycol to afford a liquid blend with 8% THQ.

TABLE 16
Treatment in soybean oil for the study of
synergy between THQ and rosemary extract.

| Sample | |
|---|---|
| # | Treatment |
| A | Untreated |
| B | EH-HANCE A103S 1000 ppm (TBHQ 200 ppm) |
| C | Liquid Monarda extract (8% THQ) 2500 ppm (THQ 200 ppm) |
| D | FORTIUM R30 Liquid 250 ppm |
| E | Liquid Monarda extract 2500 ppm + R30 250 ppm |

Synergy of THQ and oil soluble green tea extract in soybean oil. Each treatment (Table 17) was blended for 40 g total amount of soybean oil and transferred to a clear glass jar with a black closure (8 oz, Qorpak, #271012). The glass containers were capped tightly for 60° C. storage condition in dark. At each designed testing point, a small amount of sample (˜2 g) was retrieved and analyzed for primary oxidative byproducts (peroxides) and secondary oxidative byproducts (hexanal). Sample was collected on Day 0, 7, 10, 14, 21, 28. In this study, instead of using pure compound THQ Monarda extract that contains THQ was used. The Monarda extract which contained 26% THQ was dissolved in propylene glycol to afford a liquid blend with 8% THQ.

TABLE 17
Treatment in soybean oil for the study of synergy between THQ and
oil soluble green tea extract (using GT-FORT 101 C IP Liquid).

| Sample | |
|---|---|
| # | Treatment |
| A | Untreated |
| B | EH-HANCE A103S 1000 ppm (TBHQ 200 ppm) |
| C | Liquid Monarda extract (8% THQ) 2500 ppm (THQ 200 ppm) |
| D | GT-FORT 101 C IP Liquid 2500 ppm |
| E | Liquid Monarda extract 2500 ppm + GT-FORT 101 CIP |
| | 2500 ppm |

### Results

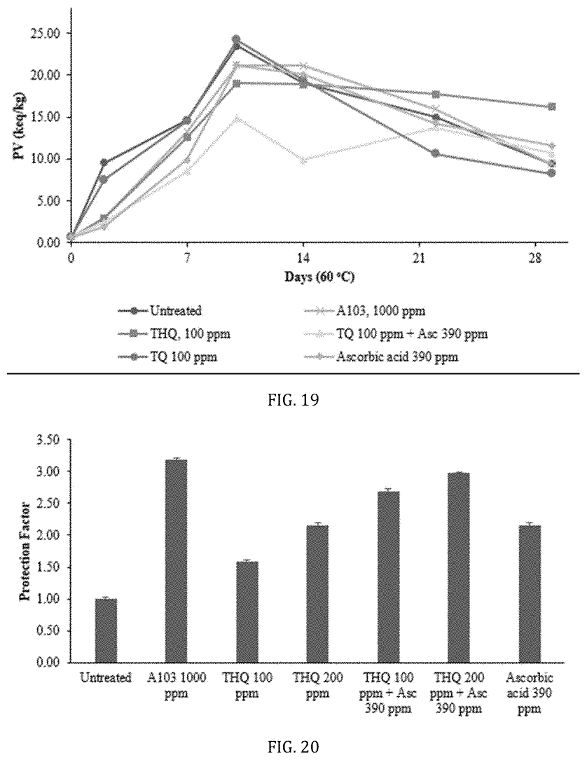

Synergy between TQ and ascorbic acid. The peroxide values are shown in FIG. 19. In this study, peroxides peaked by day 10. Values after the peak would not be indicative of the actual oxidative state of the soybean oil, and for that reason were not considered in this study. TQ did not improve the oxidative stability of soybean oil at 60° C. as the rate of peroxides accumulation was the same as the untreated. Numerically, for single ingredients, the efficacy of delaying peroxides accumulation could be ranked as ascorbic acid>THQ>TQ. The combination of TQ and ascorbic acid had big delay in peroxides accumulation. Although it is known that TQ could be reduced by ascorbic acid to THQ. THQ or ascorbic acid of the same dosage comparing to the dosages in the TQ+ascorbic acid was not able to achieve the same effect as the combination, indicating some synergistic effect.

Synergy between THQ and ascorbic acid. There is no known reaction that ascorbic acid would further reduce THQ. The OSI results of THQ, ascorbic acid and their combinations were shown in FIG. 20. The combination of the two ingredients would be able to perform better than the two of the same dosages as in the blend, indicating that there is at least an additive effect when combined.

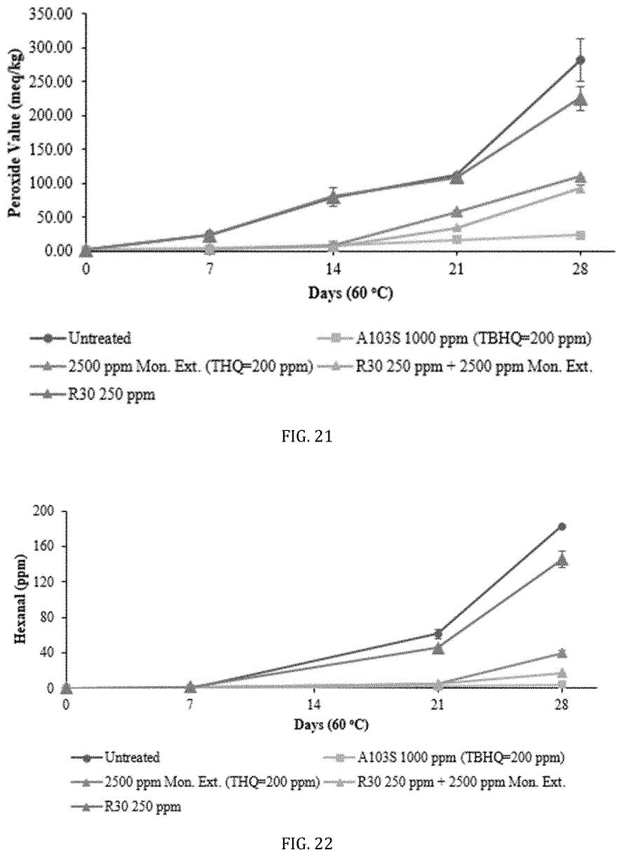

Synergy between THQ and rosemary extract. The storage stability of soybean oil that were treated with rosemary extract, THQ containing Monarda extract and their combination was shown in FIG. 21 (peroxides) and FIG. 22 (hexanal). While rosemary extract only showed marginal improvement on oxidative stability over the untreated negative control, Monarda extract was able to delay oxidation significantly. The combination of the two further delayed oxidation progress, showing them as a beneficial pair with at least additive benefit.

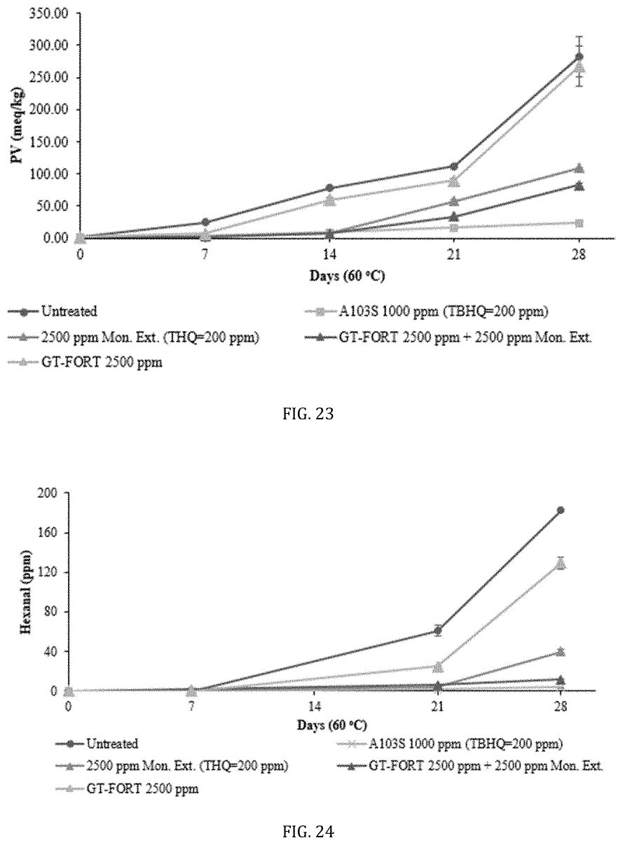

Synergy between THQ and oil soluble green tea extract. The storage stability of soybean oil that were treated with GT-FORT, THQ containing Monarda extract and their combination was shown in FIG. 23 (peroxides) and FIG. 24 (hexanal). While GT-FORT at 2500 ppm only showed marginal improvement on oxidative stability over the untreated negative control, Monarda extract was able to delay oxidation significantly. The same observation as in the combination of rosemary and green tea extract was noticed that the combination of THQ Monarda and oil soluble green tea extract further delayed oxidation progress, showing them as another beneficial pair with at least additive benefit.

### Example 5

### Evaluation of Monarda Fistulosa Extract to Control Lipid Oxidation in Cooked Ground Chicken Patties

Although Kemin Food Technologies (KFT) has had commercial success with FORTIUM® R10 Dry rosemary extract in many food applications, the mild herbal flavor of rosemary has been cited as a barrier for customers who desire to use higher levels of R10 to achieve maximum shelf life extension. Combining rosemary extract with green tea extract provided a successful strategy to avoid the flavor threshold limitations of rosemary, but the green tea catechins cause gray discoloration in lightly colored meats like poultry. Monarda fistulosa, also known as bee balm or wild bergamot, is an herbaceous perennial from the mint (Lamiaceae) family that is native to North America. Internal experiments showed that the active ingredient in Monarda, thymohydroquinone (THQ), exhibited strong antioxidant activity in vegetable oils and animal fats. Considering how it was effective in fats and oils, the next step was to evaluate its performance in various food matrices, such as meat and poultry. Ground chicken patties were treated with 0.18% FORTIUM R10 Dry, 0.18% FORTIUM® RGT12 Plus Dry, 0.18% FORTIUM 10 Dry+0.018% Monarda extract, and 0.018% Monarda extract. The lipid and flavor stability of the cooked patties was evaluated during 14 days of refrigerated (2-4° C.) storage.

Materials and methods. Monarda extract with THQ (31.2%) was used in this study. Because the dried extract was hygroscopic and highly concentrated, it was blended (Table 18) with sunflower oil and silicon dioxide using a mortar and pestle to create a free-flowing blend that would improve its dispersion in ground meat products. FORTIUM R10 Dry, a rosemary extract product and FORTIUM RGT 12 Plus Dry, a rosemary extract blend with green tea extract, were used as controls.

TABLE 18
Carriers were mixed with the Monarda extract (31.2%
thymohydroquinone) to create a free-flowing blend.

| Raw material | Percentage | Mass (g) |
|---|---|---|
| Sunflower oil | 40 | 2.64 |
| Silica dioxide | 60 | 3.3 |
| Monarda extract (31.2% THQ) | 10 | 0.66 |

Meat processing. The entire process was carried out over two days in order to create a manageable workload for one person. On the first day, fresh boneless and skinless chicken thighs (3.6 kg), boneless skinless chicken breasts (5.4 kg), and bone-in thighs with skin (1.8 kg) were purchased from a local grocery store (HyVee, Ankeny, Iowa) (Table 19). Different brands of chicken thighs and breasts were purchased to provide natural variation between the two treatment replications. All packages had the same sell-by date of five days after the purchase date. The boneless thighs contained <4% retained water (from the chilling process at the harvesting facility), and the breasts contained <1% retained water. The combination of skin, breasts, and thigh meat was used to ensure that lipid oxidation would escalate quickly enough to display treatment effects during refrigerated storage. The chicken was frozen for approximately two hours to facilitate grinding. The breasts, thighs, and skin from each supplier were ground separately using the #12 meat grinder attachment (Alfa International Corporation, Armonk, N.Y.) of a Hobart Legacy HL200 mixer (Troy, Ohio). They were collected in separate polyethylene bags (#500110 UltraSource USA, Kansas City, Mo.). The Gold n′Plump chicken was ground first, the grinder was cleaned, and then the HyVee/Tyson chicken was ground to prevent carry over between the two replicates. The skin was removed from the bone-in thighs, and it was ground through a 4.8 mm plate. The skin was ground using a finer plate than the breasts and thighs to improve its dispersion throughout the patties. The meat from the bone-in thighs was not used to avoid the chance of having bone fragments in the patties. The boneless thighs and breasts were ground using a 12.7 mm plate. Next, the skin, thigh meat, and breast meat were each divided into eight batches (Table 16) and placed into 1-gallon polyethylene storage bags (Great Value, Bentonville, Ark.). The bags were placed inside a foam cooler, and they were stored at −18° C. to partially freeze overnight (14 hours).

TABLE 19
The chicken meat used for the study originated
from two different suppliers: Gold n'Plump
(St. Cloud, MN), and Tyson (Springdale, AR).

| Ingredients | Replicate A | Replicate B |
|---|---|---|
| Skinless breasts | Gold n'Plump | HyVee Naturals (Tyson) |
| Skinless thighs | Gold n'Plump | HyVee Naturals (Tyson) |
| Chicken thigh skin | Tyson | Tyson |

The next day, the water, treatment additive, salt, and sodium tripolyphosphate (Table 20) for each batch were mixed briefly with a spoon in a glass measuring cup until the dry ingredients were dissolved. This mixture was known as the brine. The brine was poured over the surface of the meat inside the 1-gallon bag. The bag was kneaded by hand for one minute, and then each bag was placed in the freezer to partially freeze the meat while subsequent batches were mixed. After all eight batches were mixed, each batch was ground through a 6.4 mm plate using the #12 meat grinder attachment, and the grinder, plate, and knife were cleaned with hot soapy water between batches to prevent treatment carry over.

TABLE 20
Chicken patty composition.

| | | Weight | |
|---|---|---|---|
| | | per batch | |
| Ingredients | % (w/w)* | (g) | Supplier, location |
| Skinless breasts | 53.24-53.42 | 266.20-267.10 | See Table 14 |
| Skinless thighs | 35.00 | 175.00 | See Table 14 |
| Chicken thigh | 3.50 | 17.5 | See Table 14 |
| skin | | | |
| Water | 7.00 | 35.00 | Crystal Clear, Des |
| | | | Moines, IA |
| Salt | 0.50 | 2.50 | Morton's, Chicago, IL |
| Sodium | 0.40 | 2.00 | Curafos Brinesolve, |
| | | | Innophos, Cranbury, |
| tripolyphosphate | | | NJ |
| Natural plant | 0.18-0.36 | 0.90-1.80 | KFT, Des Moines, IA |
| extract | | | |

*Ingredient weights were calculated based on the total batch weight (500 g).

For each treatment batch, three patties (approximately 150 g each) were formed by hand using patty molds (#81347, Sausagemaker, Buffalo, N.Y.), and they were placed on stainless steel baking sheets. The patties were cooked in a 190° C. gas range (Jade Range, Brea, Calif.) for 15 minutes. The baking sheet was removed from the oven, the patties were flipped, and the baking sheet was returned to the oven for another 7-8 minutes until all patties reached an internal temperature of 74° C. The patties were cooled briefly on wire racks lined with paper towels. Next, each patty was individually packaged into three mil thick 7″×10″ pouches (#75001826, Bunzl PD, Kansas City, Mo.). The pouches were arranged in a single layer on stainless steel baking trays, and they were frozen overnight (−18° C.). The next day, the pouches were heat sealed without vacuum using a VFTC-420 chamber vacuum packager (MPBS Industries, Los Angeles, Calif.). The pouches were placed in a cardboard box in the freezer. After 20 days, the patties were transferred to a cardboard box in the refrigerator (2.2-3.3° C.) for up to 14 days.

Chemical analyses. Oxidative changes were measured by the thiobarbituric acid reactive substances (TBARS) method and expressed as TBARS (mg/kg sample)⁵. After 20 days of frozen storage, TBARS were measured after 1, 5, 8, 11, and 14 days of refrigerated storage.

Sensory analysis. Sensory testing was completed for both replicates after 8 days of refrigerated storage. The edges were trimmed off each patty so the texture of each piece was uniform. The samples were cut into bite sized pieces and two pieces of each treatment were placed into 3.5 oz. lidded polystyrene cups (30135J6 Dart Solo, webstaurantstore.com, Lancaster, Pa.) labeled with three digit codes. Samples were reheated in a 1000 W microwave oven for 13 seconds at 100% power. Panelists (14) who had experience in detecting rancidity in meat, tasted the patties and evaluated acceptance on a 9-point hedonic scale to the nearest 1 point, where 1=dislike extremely, 2=dislike very much, 3=dislike moderately, 4=dislike slightly, 5=neither like nor dislike, 6=like slightly, 7=like moderately, 8=like very much, and 9=like extremely. Unsalted crackers and water were provided to panelists to cleanse their palate between samples. The panelists evaluated the replicate A and B samples during separate sessions to avoid sensory fatigue.

Data Analysis. Mean TBARS values were subjected to a two-way analysis of variance (ANOVA) with time and treatment as factors, using the STATGRAPHICS® Centurion XV software package. When the ANOVA was significant (p<0.05), differences between the treatments were assessed using Fisher's least significant differences. The mean sensory acceptance values were compared using a one-way ANOVA, with treatment as the factor⁷. Differences between the treatments were assessed using Fisher's least significant differences (p<0.05).

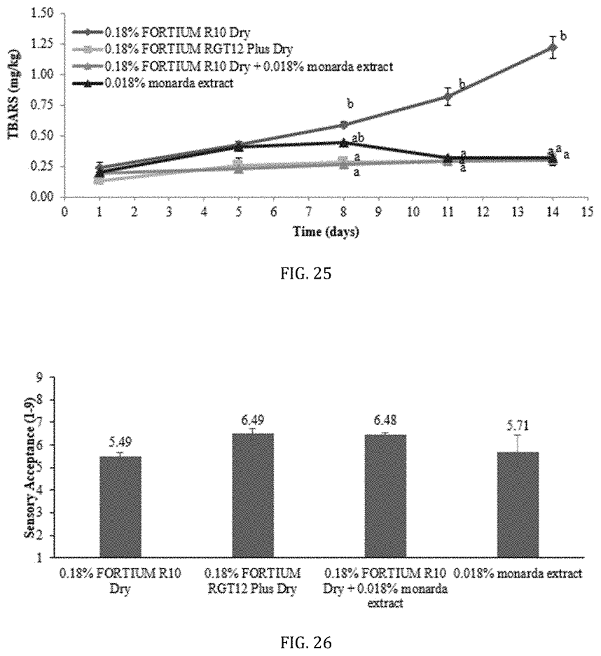

Results. During the 14-day refrigerated storage period, two-way ANOVA of the TBARS values (FIG. 25) revealed effects (p<0.01, Appendix) of treatment and time and the interaction (p<0.01) between the two factors. Based on the separation of means, the patties treated with FORTIUM R10 Dry had higher (p<0.05) TBARS than the FORTIUM RGT12 Plus Dry and FORTIUM R10 Dry+Monarda on day 8, and higher (p<0.05) TBARS than all other treatments on days 11 and 14. There were no significant differences between the TBARS of the patties treated with the two Monarda treatments and FORTIUM RGT12 Plus Dry.

After 8 days of refrigerated storage, the sensory acceptance scores (FIG. 26) of the patties ranged from 5.49-6.49, and there were no differences (p=0.2914) between the treatments. The Monarda treatments had a strong herbal flavor similar to oregano. Since the panelists evaluated the overall acceptance, they assigned scores based on their impression of the presence and absence of both desirable and undesirable flavors. Some panelists recorded negative comments about the herbal flavor (from the Monarda), but they also mentioned that those samples did not have oxidized chicken flavor. Additional studies will be conducted in the future after the Monarda extract, or another botanical source of THQ is refined to reduce the herbal flavor. The herbal flavor is a result of residual volatile compounds such as thymol. The active ingredient in Monarda, THQ does not have a strong herbal flavor on its own, so that suggested that reducing the herbal flavor will not reduce the antioxidant activity. Overall, the results indicated that the combination of rosemary and Monarda extracts performed similarly to the gold standard FORTIUM RGT12 Plus Dry.

### Example 6

### Use of Monarda Fistulosa Extract to Delay Lipid Oxidation and Color Changes in Ground Pork

### Objective

Monarda fistulosa, also known as bee balm or wild bergamot, is an herbaceous perennial from the mint (Lamiaceae) family that is native to North America. The researchers determined that the active ingredient in Monarda responsible for the antioxidant activity, thymohydroquinone (THQ), exhibited strong antioxidant activity in vegetable oils and animal fats. After determining its efficacy in fats and oils, the researchers evaluated its performance in various food matrices, such as meat and poultry. A dose response study for Monarda extract was conducted in cooked pork sausage, and validation studies were performed to test the individual components of RGT alone, in combination, and in combination with Monarda extract. Post-rigor pork shoulder was combined with water (3.0%), salt (2.0%) and the natural plant extracts to create a model pork sausage product. Oxidative stability was measured by thiobarbituric acid reactive substances (TBARS) during 11 days of refrigerated (2-4° C.) storage.

### Materials and Methods

Treatments. The raw materials used in the treatments (Table 21) were obtained from the KFT Customer Laboratory Services sampling inventory or purchased from external vendors. FORTIUM RGT12 Plus Dry was used as the positive control in the screening studies because it is the best natural plant extract product that KFT offers for extending the shelf life of cooked frozen and raw frozen pork sausage. There was no negative control because commercially available frozen pork sausage typically, if not always, contains either synthetic and/or natural antioxidants.

Monarda extract with THQ content of 26.8% was applied to this study. Since the dried extract was hygroscopic and highly concentrated, it was blended (Table 22) with sunflower oil and silicon dioxide using a mortar and pestle to create a visually homogenous, free-flowing blend that would improve its dispersion in ground meat products. The Monarda extract and the sunflower oil were placed in the mortar and ground with the pestle until the mixture resembled a thick paste. Next, the silicon dioxide was added to the paste, and mixture was ground until the silicon dioxide absorbed all of the oil and the mixture became dry enough to scrape out of the pestle. The product application rates used for the screening and validation studies (0.01, 0.02, and 0.03%) refer to the original concentrated Monarda extract. When it was reported that 0.02% Monarda extract was used, it was actually 0.2% of the diluted Monarda extract, which contained 0.02% of the concentrated extract.

TABLE 21
Carriers were mixed with the Monarda extract (26.8%
thymohydroquinone] to create a free-flowing blend.

| Raw material | Percentage | Mass [g] |
|---|---|---|
| Sunflower oil | 40 | 2.64 |
| Silica dioxide | 60 | 3.3 |
| Monarda extract | 10 | 0.66 |

TABLE 22
Pork sausage screening study 1 treatments.

Treatments
1500 ppm FORTIUM RGT 12 Plus Dry
100 ppm Monarda extract
200 ppm Monarda extract
300 ppm Monarda extract
GTE = green tea extract.
ROSAN 8CA = rosemary extract with 8% carnosic acid in sunflower oil.
Monarda = Monarda extract with 26.8% thymohydroquinone].

The second screening study was performed to test the Monarda extract, the individual components of RGT alone, in combination, and in combination with Monarda extract (Table 23). GTE (10%) was blended with silicon dioxide (90%) in the food chopper so that 0.045% of this mixture was added to the meat and provided better dispersion than adding 0.0045% straight GTE. Furthermore, ROSAN 8CA (50%) was blended with silicon dioxide (50%) in the food chopper to create a dry blend that dispersed more easily throughout the meat.

TABLE 23
Natural plant extract treatments used for the screening study 2.

200 ppm Monarda
200 ppm Monarda + 45 ppm GTE
200 ppm Monarda + 45 ppm GTE + 171 ppm ROSAN 8CA
200 ppm Monarda + 171 ppm ROSAN 8CA
171 ppm ROSAN 8CA + 45 ppm GTE
45 ppm GTE
171 ppm ROSAN 8CA
GTE = green tea extract.
ROSAN 8CA = rosemary extract with 8% carnosic acid in sunflower oil.,
Monarda = acetone extract of Monarda with 26.8% thymohydroquinone).

Meat processing. The same general meat processing steps were followed for the two screening studies. Screening study 2 was comprised of two complete replications, conducted two weeks apart. Pork steaks were purchased from a local grocery store (Fareway, Ankeny, Iowa). That cut of pork was chosen because it was pork shoulder (Boston Butt) that was sliced by the grocery store personnel, and pork butt is commonly used for post-rigor sausage. The pork steaks were deboned and cut into 1-cm cubes. Meat from all of the steaks was mixed briefly by hand before dividing into the treatment batches. Seven batches (350 g) of meat were placed into 1-gallon polyethylene storage bags (Great Value, Bentonville, Ark.) and stored in the refrigerator while the other batches were prepared. For each batch, the components of the treatment and salt (Morton's, Chicago, Ill., 2.0%) were mixed with a metal spatula in a disposable weigh boat until they were visually homogenous. The antioxidant/salt blend was sprinkled over the surface of the meat using a metal spatula so it was not concentrated in a single area. Cold water (Crystal Clear, Des Moines, Iowa, 3.0%) was applied across the surface using a plastic transfer pipet. The bag was mixed for 30 seconds to evenly distribute the water and treatments across the pork chunks. Next, the meat was frozen for one hour at −18° C. to help reduce temperature abuse during grinding.

Each treatment batch was ground through a 4.8-mm plate using the #12 meat grinder attachment (Alfa International Corporation, Armonk, N.Y.) of a Hobart Legacy HL200 mixer (Troy, Ohio). For the second screening study, replicate 2, two 150-gram round patties were shaped by hand. Only one patty (cooked) was prepared for the first screening study and the first replicate of the second screening study. One patty from each treatment was placed onto 13.3 cm expanded polystyrene trays (GENPAK 1S, Webstaurant Store, Lancaster, Pa.). The trays were covered with polyvinylchloride cling wrap (AEP 30530900, Webstaurant Store, Lancaster, Pa.). This patty was used for color measurement on day 0, then placed in a single layer on a stainless steel baking sheet, and frozen (−18° C.) overnight (16 hours). The next day, the frozen patties were placed in a cardboard box in the freezer for 188 days.

The other set of patties were cooked in a 190° C. gas range (Jade Range, Brea, Calif.) for 15 minutes. The baking sheet was removed from the oven, the patties were flipped, and the baking sheet was returned to the oven for another 7-8 minutes until all patties reached an internal temperature of 74° C. The patties were cooled briefly on wire racks lined with paper towels. Next, each patty was cut into 5 wedge-shaped pieces, and each piece was individually packaged into three mil thick 7″×10″ pouches (#75001826, Bunzl PD, Kansas City, Mo.) that were cut down to form 4 smaller pouches. The pouches were heat sealed without vacuum using a VFTC-420 chamber vacuum packager (MPBS Industries, Los Angeles, Calif.). The pouches were placed in a cardboard box in the refrigerator (2.2-3.3° C.) for up to 11 days.

Color measurement (screening study 2). For the second replicate of screening study 2, instrumental color measurements and digital photographs were taken on the day the patties were prepared and after 188 days of frozen storage. Instrumental color measurements (Commission Internationale de l'Eclairage (CIE) L* (lightness), a* (redness), and b* (yellowness)) were made using a HunterLab ColorFlex™ Colorimeter (Hunter Associates Laboratory; Reston, Va.), with Illuminant D65, 10° standard observer, and 1.25″ viewing area and port⁷. The a* values were reported because redness was the parameter that was the most indicative of the color changes caused by myoglobin and lipid oxidation. Three color measurements were taken for each patty, and the mean was reported for each treatment. Digital photographs were taken using a point-and-shoot digital camera.

Chemical Analysis. Oxidative changes in the cooked patties were measured by the thiobarbituric acid reactive substances (TBARS) method and expressed as TBARS (mg/kg sample)⁸. TBARS were measured after 1, 5, 8, and 11 days of refrigerated storage.

Data Analysis. For the validation study, mean TBARS values were subjected to a two-way analysis of variance (ANOVA) with time and treatment as factors, using the STATGRAPHICS® Centurion XV software package. When the ANOVA was significant (p<0.05), differences between the treatments were assessed using Fisher's least significant differences.

### Results

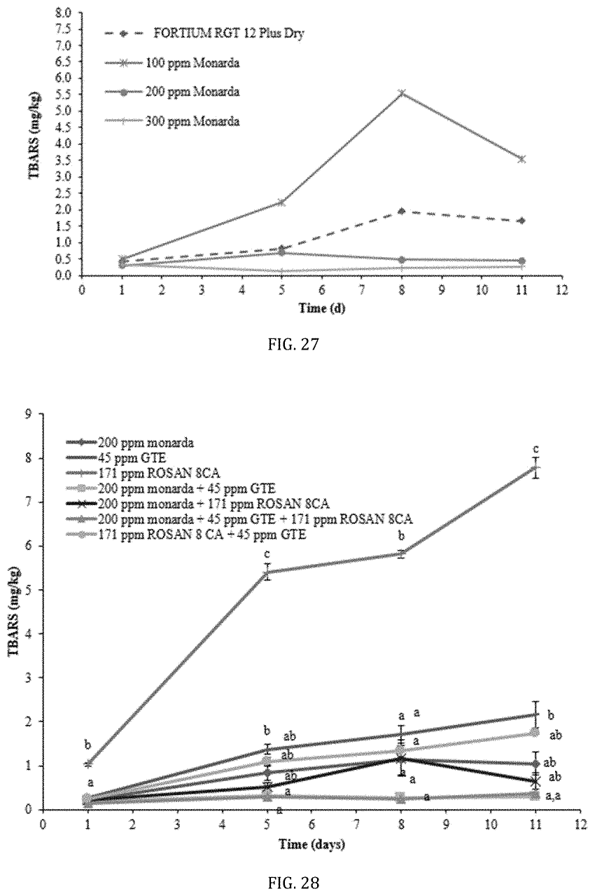

Screening Study. During the 11-day refrigerated storage period, the TBARS values (FIG. 27) increased as lipid oxidation progressed. The 200 and 300 ppm Monarda treatments had numerically lower TBARS than the gold standard treatment of FORTIUM RGT12 Plus Dry so that suggested that 200 ppm Monarda was a good candidate for further testing.

Screening Study 2. During the 11-day refrigerated storage period, two-way ANOVA of the TBARS values (FIG. 28) revealed effects (p<0.01, Appendix) of treatment and time and the interaction (p<0.01) between the two factors. Based on the separation of means, the ROSAN 8CA patties had the highest (p<0.05) TBARS of all the treatments. The GTE patties had lower (p<0.05) TBARS than the ROSAN 8CA patties, but higher (p<0.05) TBARS than the Monarda+GTE and Monarda+ROSAN 8CA+GTE patties. Additionally, the GTE patties were numerically higher yet not significantly different than the ROSAN 8CA+GTE, Monarda, and Monarda+ROSAN 8CA patties. The results showed how Monarda alone performed similarly to the gold standard ROSAN 8CA+GTE, and that there were additive effects when any of the extracts were used in combination.

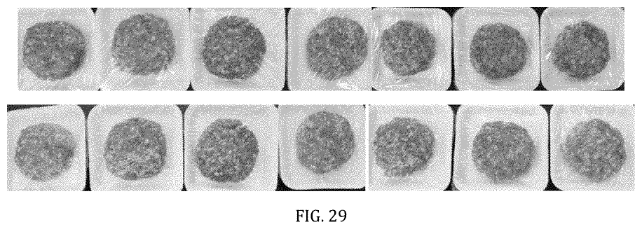

The photos (FIG. 29) of the ground pork patties showed no obvious visual differences between the treatments on day 0, and the a* values (Table 24) were within the normal range for this type of product. After 189 days of frozen storage, all of the patties were brown, but the patty treated with Monarda+GTE+ROSAN 8CA was less visibly discolored than all of the other treatments. There was a small amount redness remaining, and the a* value of 8.08 (Table 19) was indicative of this. The second-best treatment was GTE+ROSAN 8CA, with an a* value of 7.97. The a* value of Monarda+ROSAN 8CA was very similar to ROSAN 8CA alone, suggesting no additive effect, but Monarda extract had an additive effect when combined with GTE.

TABLE 24
Instrumental color a* (redness) values of ground
pork patties with various natural plant extracts.

| | a* value | a* value |
|---|---|---|
| Treatments | day 0 | day 189 |
| 200 ppm Monarda | 18.39 | 5.86 |
| 200 ppm Monarda + 45 ppm GTE | 17.15 | 7.18 |
| 200 ppm Monarda + 45 ppm GTE + 171 ppm | 14.34 | 8.08 |
| ROSAN 8CA | | |
| 200 ppm Monarda + 171 ppm ROSAN 8CA | 15.22 | 6.75 |
| 171 ppm ROSAN 8CA + 45 ppm GTE | 18.42 | 7.97 |
| 45 ppm GTE | 17.96 | 5.16 |
| 171 ppm ROSAN 8CA | 17.02 | 6.69 |

GTE = green tea extract.
ROSAN 8CA = rosemary extract with 8% carnosic acid in sunflower oil.
Monarda = acetone extract of Monarda with 26.8% thymohydroquinone).

It should be appreciated that minor dosage and formulation modifications of the composition and the ranges expressed herein may be made and still come within the scope and spirit of the present invention.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplishes at least all of the intended objectives.

1. A human or pet food additive comprising thymohydroquinone (THQ) in an amount effective to stabilize a human or pet food composition.

2. The additive of claim 1 wherein the THQ source is selected from the group consisting of Monarda fistulosa, Monarda punctata, Monarda didyma, and Monarda citriodora and Nigella sativa.

3. The additive of claim 1 wherein the THQ is added to the human or pet food composition in an amount ranging between about 10 to 1000 ppm/weight or 0.01 to 1 kg/ton.

4. A method of stabilizing food and pet foods comprising: adding a source of thymohydroquinone (THQ) to a food or pet food composition to form a stabilized food or pet food composition.

5. The method of claim 4 wherein the THQ source is selected from the group consisting of Monarda fistulosa, Monarda punctata, Monarda didyma, and Monarda citriodora and Nigella sativa.

6. The method of claim 4 wherein the THQ is added to the food or pet food in an amount of from about 10 to 1000 ppm/weight or 0.01 to 1 kg/ton.

7. The method of claim 4 wherein the THQ is added to the food or the pet food in an amount of from about 20 to 500 ppm/weight of the food or the pet food.

8. The method of claim 4 further comprising adding a second antioxidant selected from the group consisting of spearmint, rosemary, ascorbic acid, and green tea.

9. The method of claim 4 wherein the THQ is derived from a plant source or synthetic source.

10. The method of claim 4 wherein the THQ is the only antioxidant added to the food or the pet food.

11. The method of claim 4 wherein the THQ and the second antioxidant are the only antioxidants added to the food or the pet food.

12. The method of claim 4 wherein the THQ source is added in a pre-blend mix or directly incorporated into the food or pet food product.

13. The method of claim 4 wherein the THQ is added to the food or the pet food by spraying it onto the outside of the food or the pet food to form a coating.

14. A stabilized food or pet food composition comprising:
a food or a pet food product; and
an effective amount of thymohydroquinone.

15. The stabilized food or pet food composition of claim 14 wherein the THQ is derived from a plant source or synthetic source.

16. The stabilized food or pet food composition of claim 15 wherein the THQ source is selected from the group consisting of Monarda fistulosa, Monarda punctata, Monarda didyma, and Monarda citriodora and Nigella sativa.

17. The stabilized food or pet food composition of claim 14 wherein the THQ is the only antioxidant added to the food or the pet food.

18. The stabilized food or pet food composition of claim 14 wherein the THQ and the second antioxidant are the only antioxidants added to the food or the pet food.

19. The stabilized food or pet food composition of claim 14 wherein the THQ source is added in a pre-blend mix or directly incorporated into the food or pet food product.

20. The stabilized food or pet food composition of claim 14 comprising from about 10 to 1000 ppm THQ.

21. The stabilized food or pet food composition of claim 20 comprising from about 20 to 500 ppm/weight of the food or the pet food.

22. The stabilized food or pet food composition of claim 14 further including adding a second antioxidant selected from the group consisting of spearmint, rosemary, ascorbic acid, and green tea.

23. The stabilized food or pet food composition of claim 14 that does not include thymoquinone.

24. The stabilized food or pet food composition of claim 14 wherein the THQ is the only antioxidant.

25. The stabilized food or pet food composition of claim 14 wherein the THQ and the second antioxidant are the only antioxidants in the composition.

26. The stabilized food or pet food composition of claim 14 wherein the THQ is coated on the outside of the food or the pet food.

27. The stabilized food or pet food composition of claim 10 wherein the food or the pet food comprises a fat/oil matrix.

28. The stabilized food or pet food composition of claim 10 wherein the food or the pet food comprises a protein matrix.
